(19) United States
(12) Patent Application Publication
(10) Pub. No.: US 2024/0311927 A1
(43) Pub. Date: Sep. 19, 2024

(54) SECURITY AND IDENTITY VERIFICATION SYSTEM AND ARCHITECTURE

(71) Applicant: CSIdentity Corporation, Austin, TX (US)

(72) Inventors: Brian Stack, San Clemente, CA (US); Iris Connealy-Seri, Belmont, MA (US); Neli Coleman, Alexandria, VA (US); Omar Salam, Irvine, CA (US); Adam Kennedy, Austin, TX (US)

(21) Appl. No.: 18/612,735

(22) Filed: Mar. 21, 2024

Related U.S. Application Data
(63) Continuation of application No. 17/934,038, filed on Sep. 21, 2022, now abandoned.
Application No. 17/934,038 is a continuation of application No. 17/116,423, filed on Dec. 9, 2020, now abandoned.
Application No. 17/116,423 is a continuation of application No. 16/189,990, filed on Nov. 13, 2018, now Pat. No. 10,896,472.
(60) Provisional application No. 62/586,014, filed on Nov. 14, 2017.

(51) Int. Cl. G06Q 40/12; G06F 21/62; G06Q 10/0635; G06Q 50/26; H04L 9/40; H04L 67/306

(52) U.S. Cl. CPC G06Q 40/123; G06F 21/6245; G06Q 10/0635; G06Q 50/265; H04L 63/0428; H04L 67/306

(57) ABSTRACT

Embodiments of a security and identity verification system are disclosed. The security and identity verification system may comprise a system that conducts automated identify verification of tax filers and generates electronic alerts to send to tax filers upon filing of a tax form with a tax service provider. The tax fraud alert system may also provide remediation services in coordination with tax service providers in the event a fraudulent form is filed; and/or validate tax identity information and the corresponding good or best tax filer contact information in order to notify the tax filer in a timely manner.

### CROSS-REFERENCE AND PRIORITY

This application is a continuation of U.S. patent application Ser. No. 17/934,038, filed Sep. 21, 2022, which is a continuation of U.S. patent application Ser. No. 17/116,423, filed Dec. 9, 2020, which is a continuation of U.S. patent application Ser. No. 16/189,990, filed Nov. 13, 2018, which claims the benefit of U.S. Provisional Patent Application Ser. No. 62/586,014, filed Nov. 14, 2017, the entire contents of which are hereby incorporated herein by reference in their entirety and for all purposes.

### LIMITED COPYRIGHT AUTHORIZATION

A portion of the disclosure of this patent document includes material which is subject to copyright protection. The copyright owner has no objection to the facsimile reproduction by anyone of the patent document or the patent disclosure as it appears in the Patent and Trademark Office patent file or records, but otherwise reserves all copyrights whatsoever.

### FIELD OF THE DISCLOSURE

The present disclosure generally relates to information security for tax filings in a computer environment.

### BACKGROUND OF THE DISCLOSURE

In recent years, the number of third party, unwanted intrusions into private computing environments has continued to increase. These intrusions may come in a variety of forms, such as malicious third party systems attempting to emulate or impersonate the systems of a standard user. Such intrusions can be very disruptive and may, for example, immobilize operations, allow for the unauthorized access to sensitive data, or allow for the embezzlement of a user's account and corresponding funds.

### SUMMARY OF EXAMPLE EMBODIMENTS

Various systems and methods are disclosed which include features relating to security and identity verification systems and architectures to analyze and detect unauthorized third party intrusions and/or access.

The systems, methods, and devices of the disclosure each have several innovative aspects, no single one of which is solely responsible for the desirable attributes disclosed herein.

In one embodiment, a fraud detection and alert system is disclosed. The fraud detection and alert system may comprise: one or more data stores configured to store computer-executable instructions; a network interface configured to communicate with a plurality of network service devices; and one or more physical computer processors in communication with the one or more data stores, wherein the computer-executable instructions, when executed, configure the one or more processors to: receive, via the network interface, an electronic request for a filing of an application, wherein the electronic request is associated with a first user and includes user data associated with the first user; match, based on the electronic request, the user data associated with the first user to verification data stored in one or more searchable databases, wherein the verification data is associated with the first user; transmit notification to first user device associated with the first user regarding the successful application filing of the first user's application; receive an indication from the first user device indicating a possible fraudulent electronic request; determine, based on the indication, that the electronic request is fraudulent; and generate electronic instructions to stop the filing of the application as requested by the electronic requests.

In another embodiment, a computerized method for detecting fraudulent tax filings is disclosed. The computerized method may comprise: receiving, via a network interface, an electronic request for a filing of an application, wherein the electronic request is associated with a first user and includes user data associated with the first user; matching, based on the electronic request and using one or more computer processors, the user data associated with the first user to verification data stored in one or more searchable databases, wherein the verification data is associated with the first user; transmitting, via one or more computer processors, notification to first user device associated with the first user regarding the successful application filing of the first user's application; receiving, via a network interface, an indication from the first user device indicating a possible fraudulent electronic request; determining, via one or more computer processors, based on the indication, that the electronic request is fraudulent; and generating, via one or more computer processors, electronic instructions to stop the filing of the application as requested by the electronic request.

In a further embodiment, a non-transitory storage medium for storing instructions adapted to be executed by a processor to perform a method for automatically detecting fraudulent tax filings is disclosed. The instructions may comprise: receiving an electronic request for a filing of an application, wherein the electronic request is associated with a first user and includes user data associated with the first user; matching, based on the electronic request, the user data associated with the first user to verification data stored in one or more searchable databases, wherein the verification data is associated with the first user; transmitting notification to first user device associated with the first user regarding the successful application filing of the first user's application; receiving an indication from the first user device indicating a possible fraudulent electronic request; determining based on the indication, that the electronic request is fraudulent; and generating electronic instructions to stop the filing of the application as requested by the electronic request.

Although certain embodiments and examples are disclosed herein, the subject matter extends beyond the examples in the specifically disclosed embodiments to other alternative embodiments and/or uses, and to modifications and equivalents thereof.

### BRIEF DESCRIPTION OF THE DRAWINGS

FIG. 1A illustrates example embodiments of a security and identity verification system.

FIG. 1B illustrates example embodiments of a tax fraud alert system.

FIGS. 1C-1, 1C-2, 1D, and 1E illustrate example processes that can be implemented by embodiments of one or more components of the tax fraud alert system.

FIG. 2A illustrates example embodiments of an identity verification engine.

FIG. 2B illustrates example embodiments of a contact engine.

FIG. 2C illustrates example embodiments of an alert notification engine.

FIGS. 2D-1 and 2D-2 illustrate flow diagrams for embodiments of call center support processes.

FIG. 2E illustrates a flow diagram for embodiments of a web portal support process.

FIG. 2F illustrates a flow diagram for embodiments of a dispute process.

FIG. 3 illustrates an embodiment of a computing system which may implement example embodiments of one or more components of the tax fraud alert system.

Throughout the drawings, reference numbers are re-used to indicate correspondence between referenced elements. The drawings are provided to illustrate embodiments of the subject matter described herein and not to limit the scope thereof.

Although certain embodiments and examples are disclosed herein, the subject matter extends beyond the examples in the specifically disclosed embodiments to other alternative embodiments and/or uses, and to modifications and equivalents thereof.

### DETAILED DESCRIPTION OF VARIOUS EMBODIMENTS

### A. Overview

Tax authorities such as a state or federal government continuously combat fraudulent activities such as noncompliance, evasion, identity theft and refund fraud. Unfortunately, despite widespread government crackdowns, fraudsters are finding new and creative ways to defraud the government and legitimate taxpayers. For example, some individuals and groups acquire personally identifiable information (PII) from the deceased, dumpster dive, hack financial systems, buy information from someone not filing a return or otherwise steal it from legitimate sources such as a doctor's office. This PII can then be used to fill out tax returns, add fraudulent income information, and request false deductions.

Fake returns and identity theft cause the government to lose billions of dollars. For example, during the first nine months of 2016, the Federal tax authority flagged roughly 787,000 fake returns claiming $4 billion in refunds, and 237,750 taxpayers filed affidavits saying they, too, were victims of tax identity theft. (See https://www.irs.gov/newsroom/irs-security-summit-partners-expand-identity-theft-safeguards-for-2017-filing-season-build-on-2016-successes). According to a May 2014 Governing Institute research study of 129 state and local government officials, 43 percent of respondents cited identity theft as the biggest challenge their agency faces regarding tax return fraud. Nationwide, stealing identities and filing for tax refunds is one of the fastest-growing nonviolent criminal activities. Although federal agencies and some states have been able to start reducing identity theft tax refund fraud for individuals, tax refund fraud involving businesses is on the rise. These activities burden government agencies and rob taxpayers by preventing returns from reaching the right people. Clearly, tax fraud through identity theft is still a major issue facing the tax authorities and taxpayers.

Most recently in a June 2017 report by the Electronic Tax Administration Advisory Committee (ETAAC) published by the Internal Revenue Service (IRS), Identity Theft Tax Refund Fraud (IDTTRF) was described as a tough problem for tax authorities to solve. The report went further to say that criminals are incentivized by the potential availability of billions of dollars in refunds, particularly driven by refundable tax credits intended to help low and moderate-income Americans. The criminals are smart, nimble, motivated and well-funded.

Tax collection agencies, such as tax authorities at the local, state, and federal level, combined continue to lose billions of dollars in tax refund fraud. Tax service providers (TSPs), such as the tax collection agencies or a private tax preparation organization such as Intuit, H&R Block, or other tax preparation business, are well-aware of the magnitude of the tax fraud problem. However, budgetary constraints and legal mandates have created a system that is often unable to follow up on the red flags until after a refund check has been sent. In addition, the consumer or customers' identities and ability to receive a timely return may be put at risk in the process. Some TSPs continue to expand filters used to detect identity theft tax refund fraud. Tax returns identified by these filters can be held during processing until the TSPs can verify the taxpayers' identities. This filtering approach, however, is problematic because it focuses only on fraud detection rather than proactively informing a tax payer of a tax filing to enable prevention. Further, as tax-refund fraud has soared and hit a whopping $21 billion in 2016, up from just $6.5 billion two years ago, the problem of tax-refund fraud is growing quickly and is compounded by an outdated fraud-detection system that has trouble identifying many attempts to trick it. Although federal agencies and some states have been able to start reducing identity theft tax refund fraud for individuals, tax refund fraud involving businesses is on the rise.

Security practices can have a significant impact on the tax experience and taxpayer behavior. Improving the taxpayer experience may require sustained creativity and focus for a TSP to build systems that are both secure and, conversely, easy to access and use from a taxpayer perspective. A system that is secure, but that few can use, may not be successful for a TSP as it expands some of its key online services. Thus, in some embodiments, a TSP may strive to achieve a situation where services are both secure and easy to use and access. For example, a TSP may benefit from a system that provides more intelligent and customizable fraud detection checks to inform the TSP, before a refund check is processed and mailed out or sent to a direct deposit account, that a tax transaction is at risk of being fraudulent, and/or provides multiple channels to notify their tax payers or customers proactively of both legitimate and fraudulent returns. Further, consumers may also benefit from a system which can: preemptively notify them that tax forms have been filed with their tax identifier (ID) or their business' tax ID regardless of whether they have been flagged as a potential fraudulent tax filing; provide a channel via online or through call centers to contact the IRS or its proxy to remediate the issue if they believe the tax filing is fraudulent; and/or provide a system to track the progress of their cases.

To provide an improved computer system for detecting and alerting tax frauds, embodiments of a security and identity verification system or tax fraud alert system described herein promotes a more proactive and interactive relationship between the taxpayer and government employees to improve taxpayer service, enforcement and operations. Instead of the typical approach of trying to enhance detection of fraudulent tax form submissions, this solution aims to send positive notifications to tax payers when their tax return is filed and/or when any tax form is filed using the tax payers' individual tax ID or business tax ID(s). In some embodiments, the solution can leverage data from one or more credit bureaus and other data sources and algorithms to find good or even the best contact information for a tax payer and send the tax alerts. In some embodiments, the solution can also leverage other software suites and call centers to handle callbacks from users that received a tax alert and suspect fraud or have questions.

As an example, in some embodiments, a portion of the tax fraud alert system can be run at data centers of a tax authority if the tax authority's integration model does not allow non-public personal information (NPPI) data from tax forms to leave their premises, or where the some or all portions of the NPPI data can leave the premise, the system can offer a set of Application Programming Interfaces (APIs)/batch processes to send a subset of NPPI data from tax forms to another entity for the system to determine the correct identity(ies) tied to the individual tax ID or business tax ID in the tax form, selecting contact information to send the tax alert, and/or for handling customer support for those that receive a tax alert. While processing the NPPI submitted, in some embodiments, the system may also perform various types of fraud checks. Some example fraud checks can include: SSN check, multiple submissions to the same address (velocity of the same address being used), multiple submissions to the same bank account, verify against deceased records, communication checks (email, phone numbers, residential address), checking NPPI data in the tax filing against the credit bureau data to look for discrepancies and to verify communication channels, and/or a combination of positive activity tax alerts to all consumers or customers filing taxes and customizable fraud checks.

By notifying the taxpayer that their identity, tax ID, or business tax ID has been used to file a tax form, the consumer can respond to tax authorities and stop the process if they have not submitted a tax form. This proactive communication can prevent loss of tax refunds associated with identity fraud, significantly reduce fraudulent or unauthorized individual or business tax filings whether a refund is involved or not, and alert taxpayers to possible identity theft. In addition, in the June 2017 Electronic Tax Administration Advisory Committee (ETAAC) report published by IRS, the committee cited among its principal recommendations in addressing identity based tax fraud the need to improve authentication practices, including using innovative pilots and finding a replacement solution for the outmoded 2016 AGI/PIN e-file signature verification.

As further described herein, embodiments of the tax fraud alert system can use Personally Identifiable Information (PII) to verify a taxpayer's identity. For example, the PII used on the tax filing can be verified as belonging to the legitimate taxpayer through an independent verification process. Once the legitimate taxpayer is located, the most recent contact information including landline or mobile phone number, mailing address, and/or email associated with the legitimate taxpayer can be sent an alert notifying the taxpayer that a tax return has been filed with the taxpayer's credentials. If the legitimate taxpayer has not submitted a filing, the taxpayer can be provided with an option to contact the tax authority's customer service center or visit a web portal to get more information, and if necessary initiate a dispute and potentially stop payment of any tax refunds tied to the tax filing. The tax fraud alert system can offer a branded call center and/or a branded web portal to handle customers' or tax payers' inquiries about the tax alerts.

In some embodiments, the function of the tax fraud alert system can be twofold—(1) the successful delivery of the tax alert can serve to confirm the legitimate tax payer has filed the return and/or (2) the verification process ensures delivery of alerts to the legitimate taxpayer which results in additional information that can be useful in the overall review of the tax filing. TSP can be provided with a result from the taxpayer verification process, such as, for example, no taxpayer verified through information provided, taxpayer found to be deceased, or taxpayer/location found to be prison. One or more of these results may allow a tax authority to take next steps in the return evaluation process independent of taxpayer response to alerts or content of alerts generated.

Advantageously, in some embodiments, the alert does not add any additional time for processing, but may even shorten the time for processing because if a legitimate taxpayer receives the alert and notifies a tax authority that the taxpayer did not submit the tax filing in question, the tax filing can be sent immediately to fraud prevention for further evaluation. Unlike some existing tax fraud prevention efforts requiring the taxpayer to first obtain a PIN from the TSP to submit it in a tax form, in some embodiments, this tax fraud alert system does not require any taxpayer interaction to be in effect. The legitimate taxpayer does not have to opt-in in order to receive a notification that a tax form has been filed using tax ID or business tax ID that belongs to him or her.

In some embodiments, before sending a taxpayer filing alert, another entity (such as, for example, a credit bureau) can independently verify identity of the taxpayer, and independently locate and verify a mobile phone and/or other contact information associated with the legitimate taxpayer and/or find the best mobile phone number and other contact information. In some embodiments, alerts may only be sent if both the taxpayer and contact information can be verified. If taxpayer receiving the tax alert has submitted a tax form in his or her name or on behalf of a business, then he or she does not have to take any action. The majority of alerts may serve as a notification with no action required. If the taxpayer has not filed any tax form, the taxpayer can be provided with a call center number to contact for remediation efforts. The alerting process, while largely frictionless to the taxpayer, becomes an indispensable, proactive tool in combatting identity theft tax return fraud at the onset.

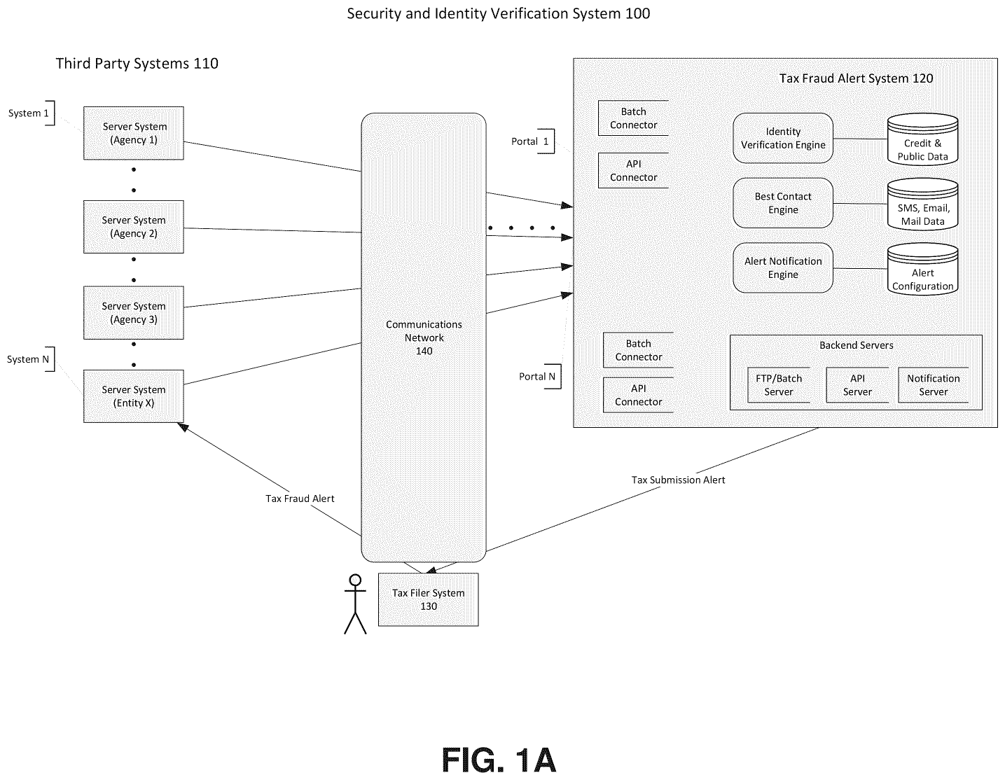

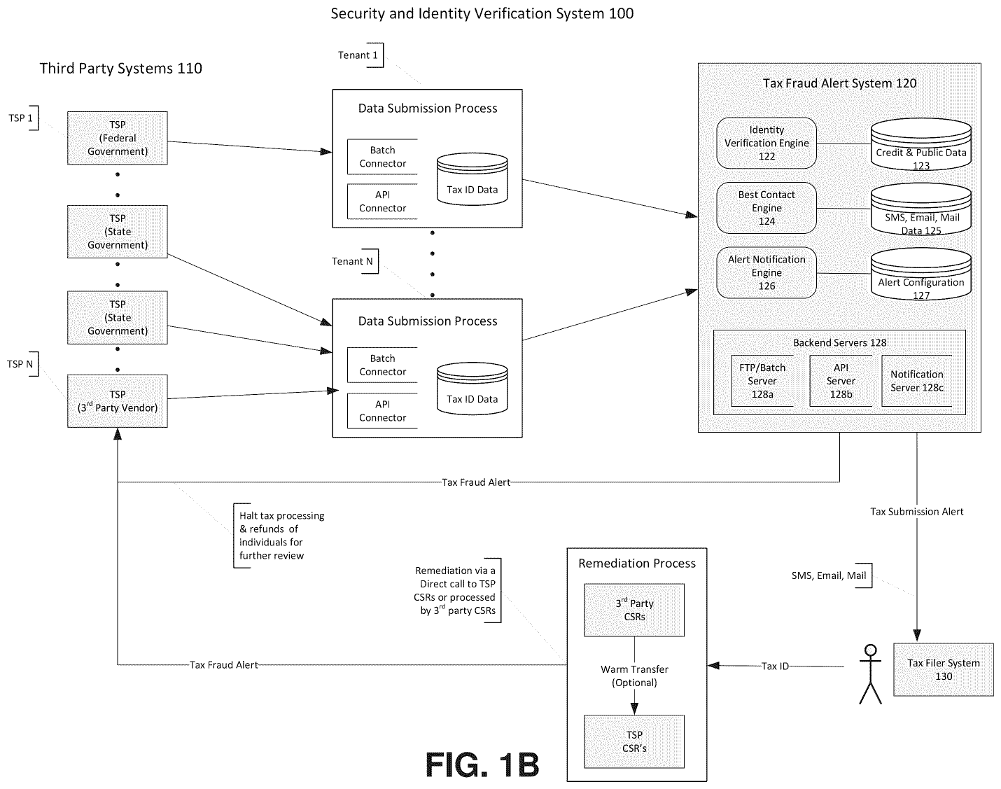

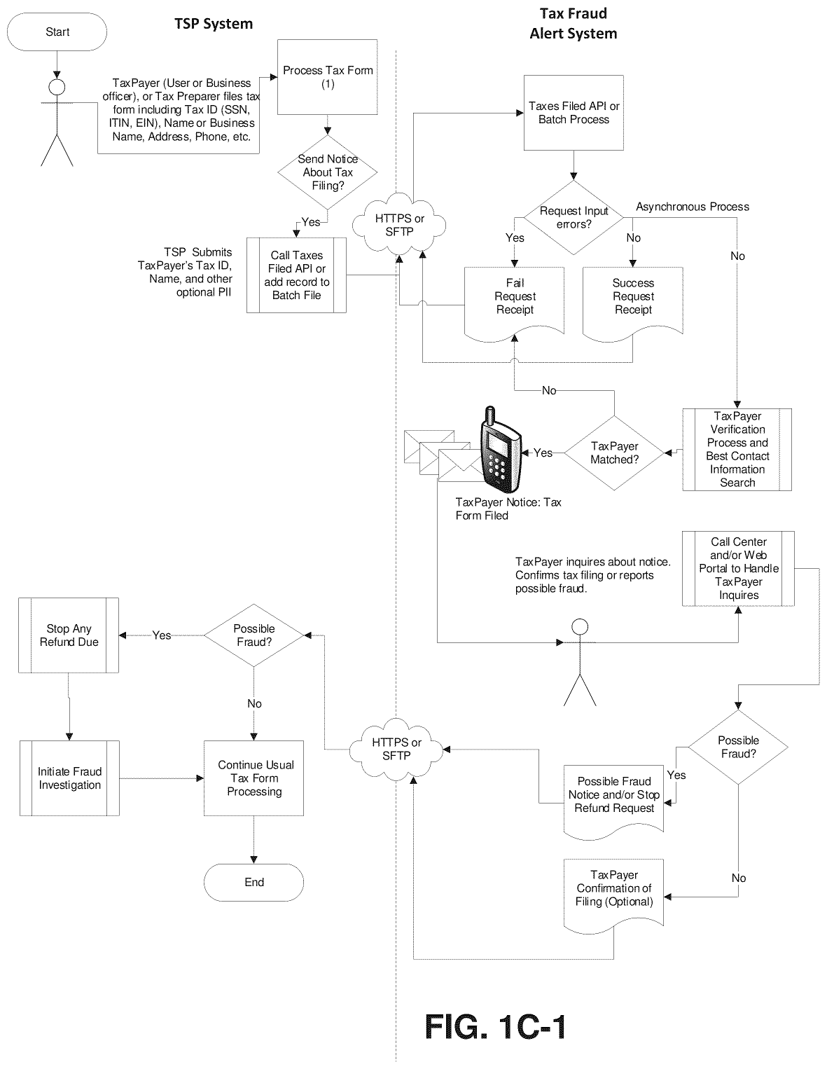

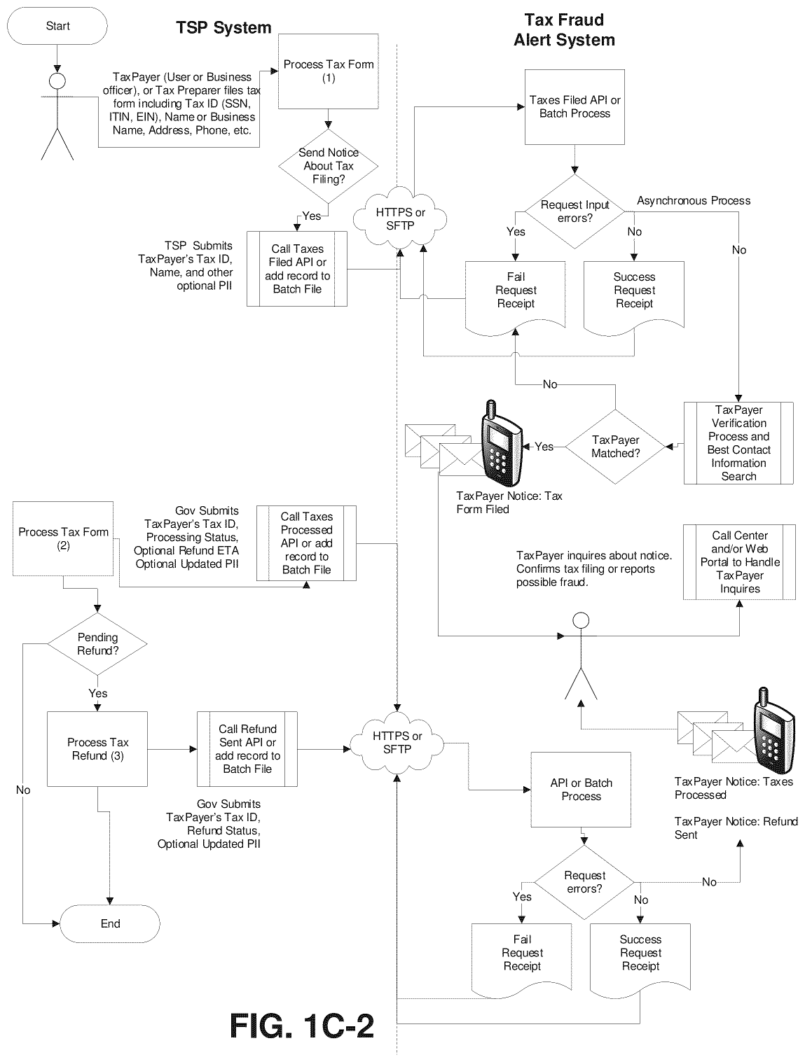

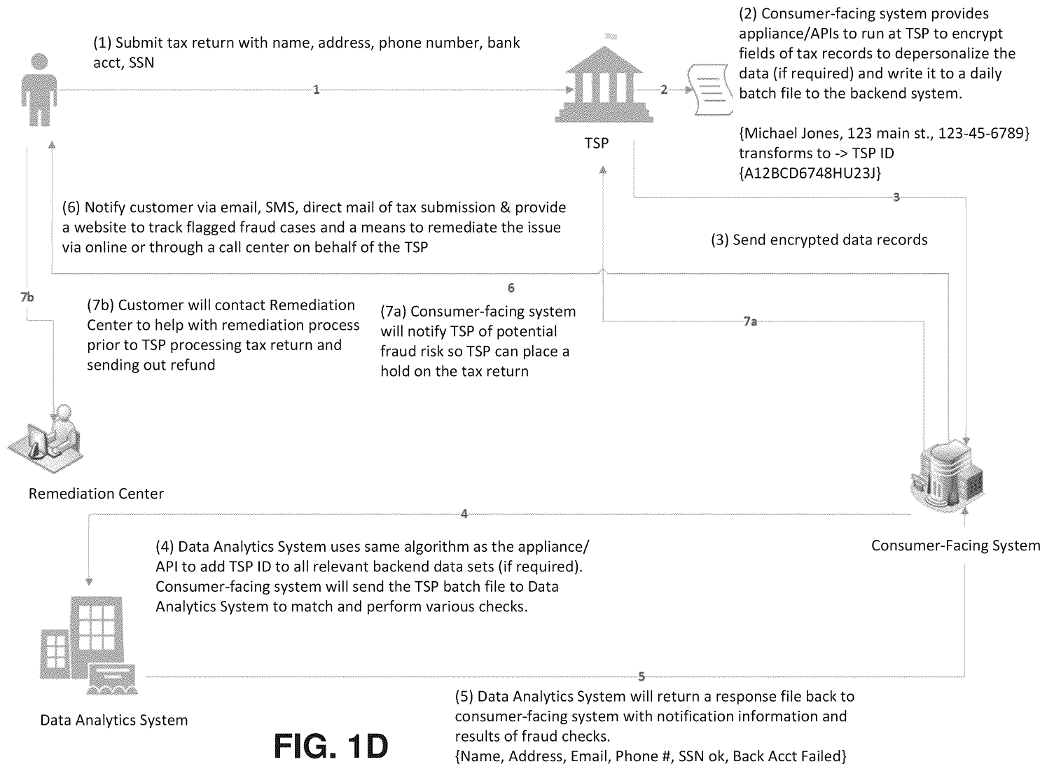

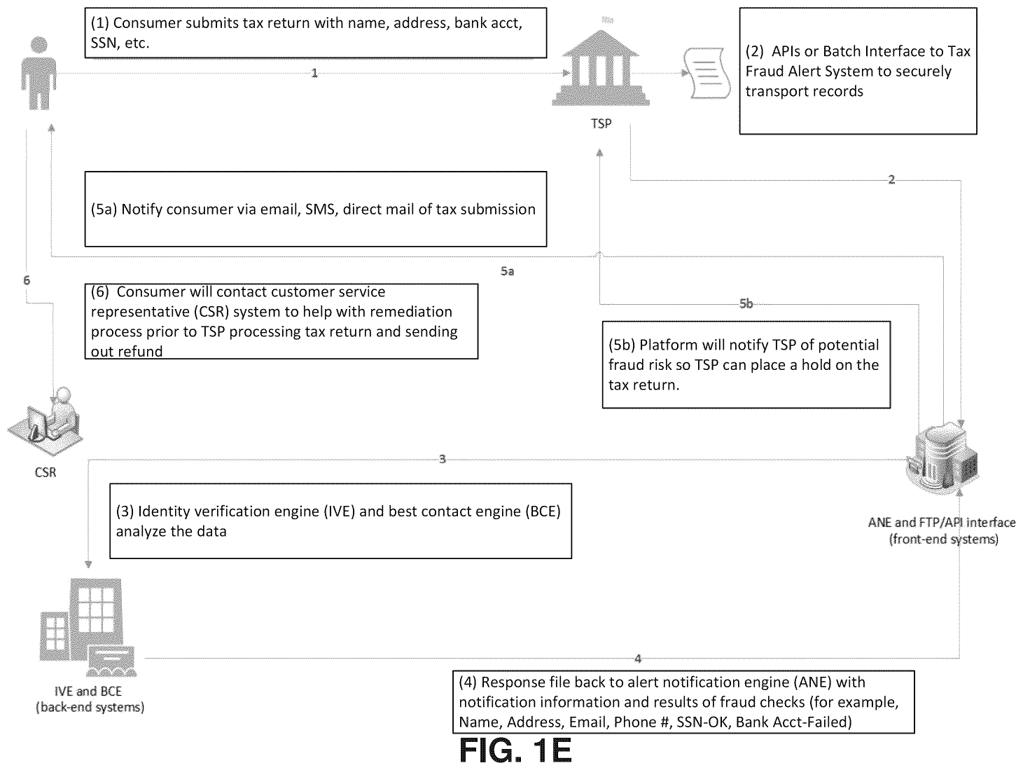

FIG. 1A illustrates an example embodiment of a security and identity verification system 100 which can be used to provide tax alerts. The exemplary security and identity verification system 100 includes a set of third party systems 110 which communicate with a tax fraud alert system 120 and with tax payer/tax filer systems 130 via a communications network 140. It is recognized that in some fraudulent situations, the tax payer and the tax filer are not the same entity, but the use of the term “tax filer” herein is meant to apply to the tax payer and not a fraudulent tax filer.

The security and identity verification system 100 may include multiple third party system 110 which communicate with the tax fraud alert system 120, such as to submit data, provide information on filed tax returns, and receive alerts for possible tax filing fraud. In some embodiments the third party systems 110 may include TSP systems (for example, systems of the US Federal Government, systems of state governments), third party vendor systems, third party data provider systems, and/or other third party systems. The third party systems 110 may be implemented using a variety of devices including, for example, personal computers, servers, tablets, smart phones, smart watches, car consoles, or the like, alone or in combination. The exemplary third party systems 110 include computer hardware and/or software that allows the devices to communicate with the tax alert fraud system 120 as well as one or more of the tax payer/tax filer systems 130 via the communications network 140. The tax fraud alert systems 120 may include a portal or other software or code that allows the TSP systems 110 to provide configurations for how the respective TSP system 110 would like to configure its alerts. The tax alert fraud systems 120 may be partitioned such that one TSP system 110 and its private configurations are not accessible to or viewable by another TSP system 110.

The security and identity verification system 100 may include multiple tax payer/tax filer systems 130 which are utilized by tax filers to, among other things, provide tax submissions, receive tax alerts, and/or review refund status. The tax payer/tax filer systems 130 may be implemented using a variety of devices including, for example, personal computers, servers, tablets, smart phones, smart watches, car consoles, or the like, alone or in combination. The exemplary tax payer/tax filer systems 130 include computer hardware and/or software that allows the devices to communicate with the tax alert fraud system 120 as well as one or more of the third party systems 110, such as a tax service provider via the communications networks 140. To simplify discussion, but without limiting the present disclosure, FIG. 1 is described herein and illustrates only one tax payer/tax filer systems 130.

In some embodiments, the communications network 140 comprises one or more of local area network (LAN), wide area network (WAN), and/or the Internet, for example, via a wired, wireless, or combination of wired and wireless communication links. The communications network 140 may communicate with various computing devices and/or other electronic devices via wired or wireless communication links. The communications network 140 may be used to share resources and may be used for the analog and/or digital transfer of data and information. In some embodiments, the communications network 140 can be used to enable multiple devices access to a single system, enable file sharing across the communications network 140, share software programs on remote systems, or make information easier to access and maintain among network users.

It is recognized that the term “remote” may include data, objects, devices, components, and/or modules not stored locally, that are not accessible via the local bus. Thus, remote devices may include a device which is physically stored in the same room and connected to the user's device via a network. In other situations, a remote device may be located in a separate geographic area, such as, for example, in a different location, country, and so forth.

### B. Tax Fraud Alert System

FIG. 1B illustrates an example embodiment of a tax fraud alert system 120. The tax fraud alert system 120 comprises a system that provides alerts to tax filers upon a successful filing of a tax form with a TSP. The tax fraud alert system 120 can also provide remediation services in coordination with TSPs in the event a fraudulent form is filed; and/or validate tax identity information and the corresponding good or best tax filer contact information in order to notify the tax filer in a timely manner. This can be a multi-tenant system in which multiple TSPs are supported by the data submission process each with their own defined configuration of the type of Tax ID information (SSN, name, address, and so on) that is submitted to the tax fraud alert system 120. Each TSP may utilize one or more of the batch connectors or API connectors available in the tax fraud alert system 120 to submit data to the tax fraud alert system 120.

In some embodiments, the tax fraud alert system 120 can include three sub-systems in FIG. 1B: (1) Identity Verification Engine (IVE) 122, (2) Best Contact Engine (BCE) 124, and (3) Alert Notification Engine (ANE) 126, with each engine having its own configuration database to support per tenant business rules. In some embodiments, the IVE 122 and BCE 124 may be optional per tenant, and the data submitted is allowed to bypass these engines and go straight to the ANE 126 to notify tax filers. The IVE 122 can include a configurable rules engine to review incoming data submission to validate and select the best or close matches to the true identity using the combination of data attributes (for example, social security number, name, and address) with known proprietary and public datasets. The BCE 124 can also include a configurable rules engine that reviews incoming data attributes along with data attributes from proprietary and public records to determine at least one valid communication channel (for example, as many valid communication channels as possible, one communication channel, X communication channels) that can be linked to the legitimate tax filer.

In some embodiments, the output of the tax fraud alert system 120 can include one or more of the following options. The first option may include a tax alert to each tax filer based on the results of the IVE 122 and/or the BCE 124. The second option may include a tax alert to identity submitted in the original tax form if the optional IVE 122 and BCE 124 processes were not chosen or if the IVE 122 and/or the BCE 124 were unable to verify a different identity or different contact information than what was submitted in the tax form. This option can still be useful to stop cases where the thief uses the correct information of the tax filer and only changes the account information to be used for tax refunds. The TSP may also use this option to test the notification process and the remediation process for users that receive the notifications. The third option may include a tax fraud alert to the associated TSP with all records that have been flagged by the IVE 122 and the BCE 124. This option can be used by the TSP to initiate fraud investigations on flagged records.

Upon receipt of the tax alert via SMS, email, and/or direct mail, in some embodiments the tax filer may be given detailed instructions on whom to contact to remediate the issue in the event the tax filers believe a tax form was fraudulently filed in the tax filer's name or the name of the tax filer's business. In some embodiments, the tax filer may be automatically redirected to a remediation server which can provide automated remediation processes to assist the tax filer. During this remediation process, in some embodiments, a tax fraud alert can be sent to the associated TSP to halt any tax refund in process and to initiate a fraud review of the tax form, such as via a warm transfer or other transfer or data.

In some embodiments, the tax alert comprises one or more encrypted data packets which stores information about the tax alert and is configured to be sent over an electronic communications network, such as the Internet.

### C. Tax Fraud Alert System Processes

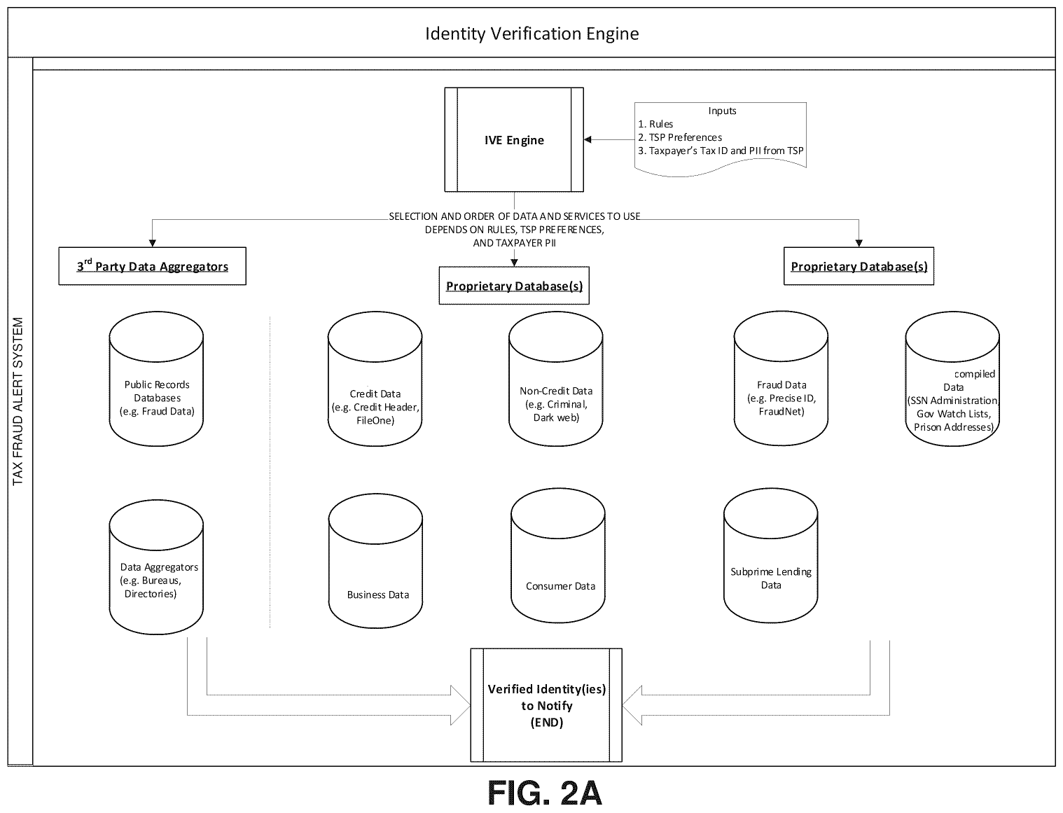

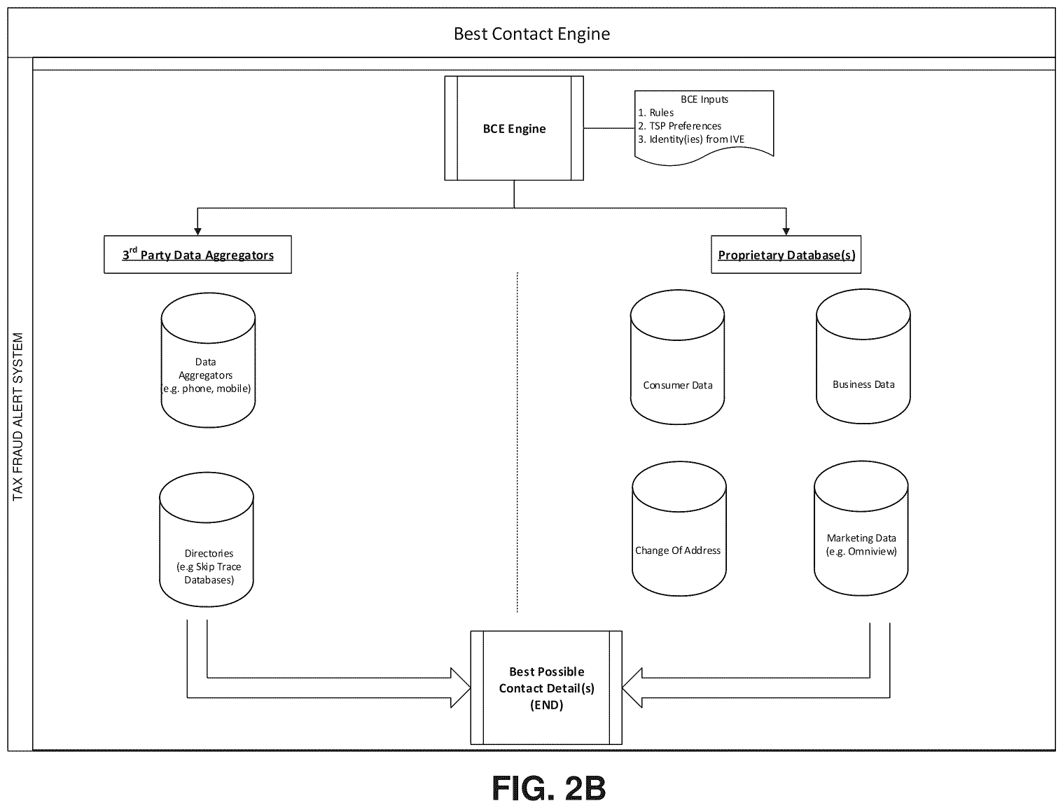

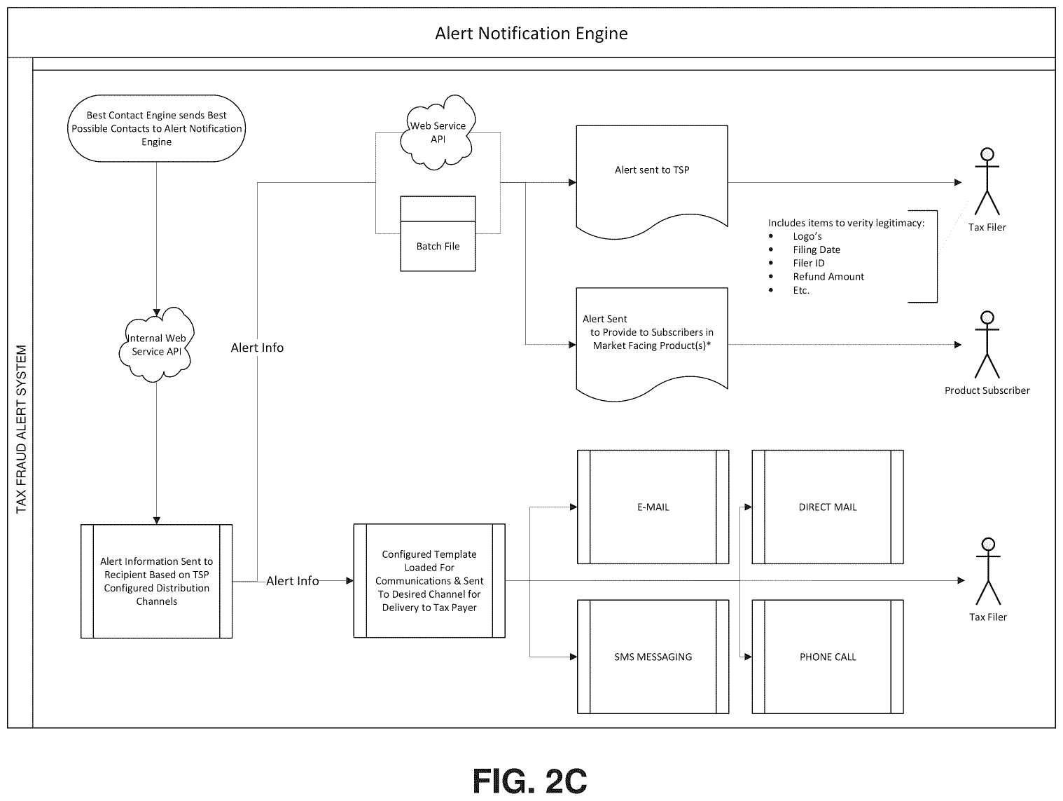

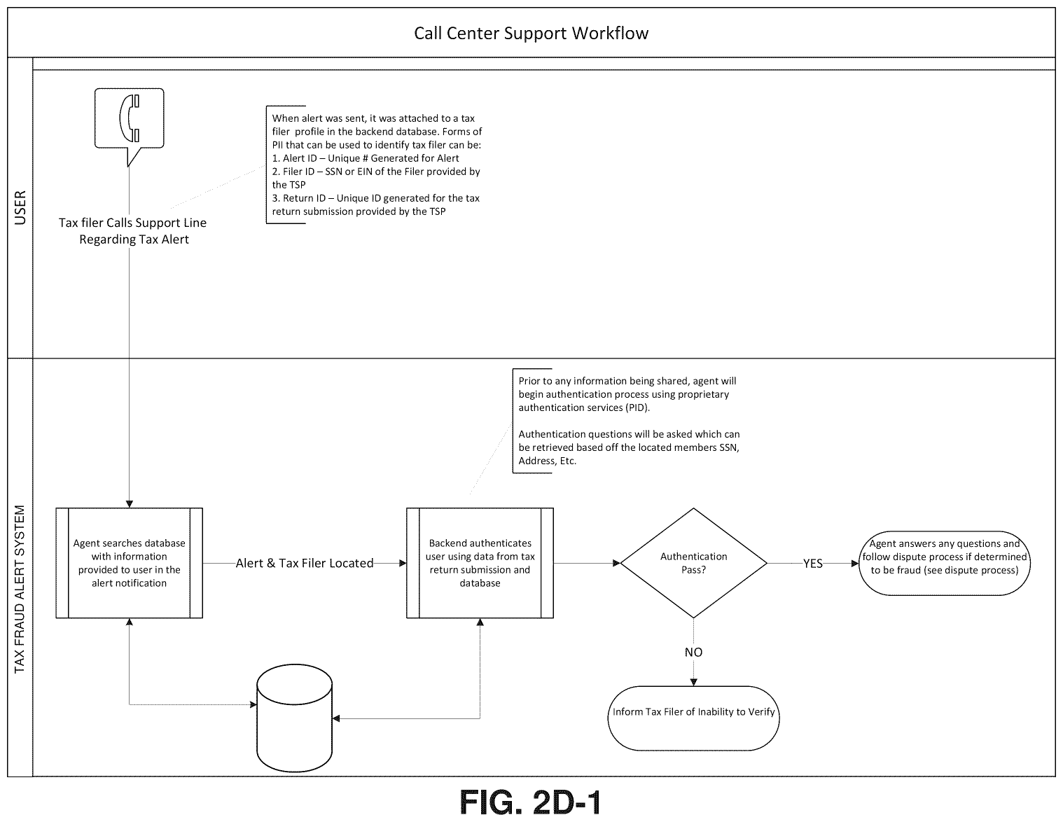

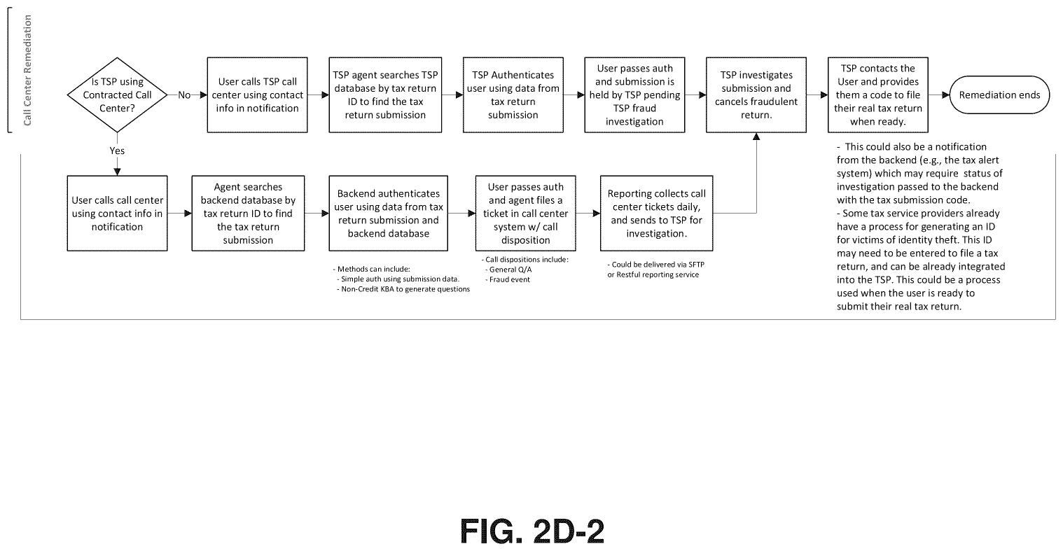

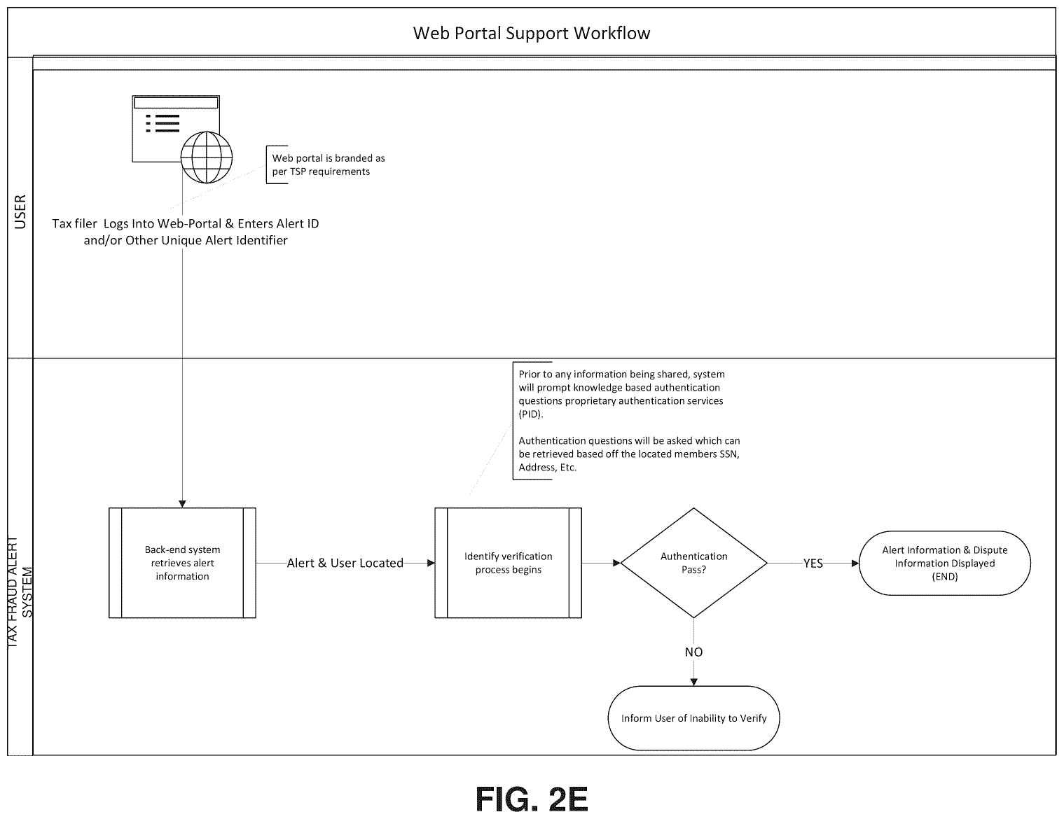

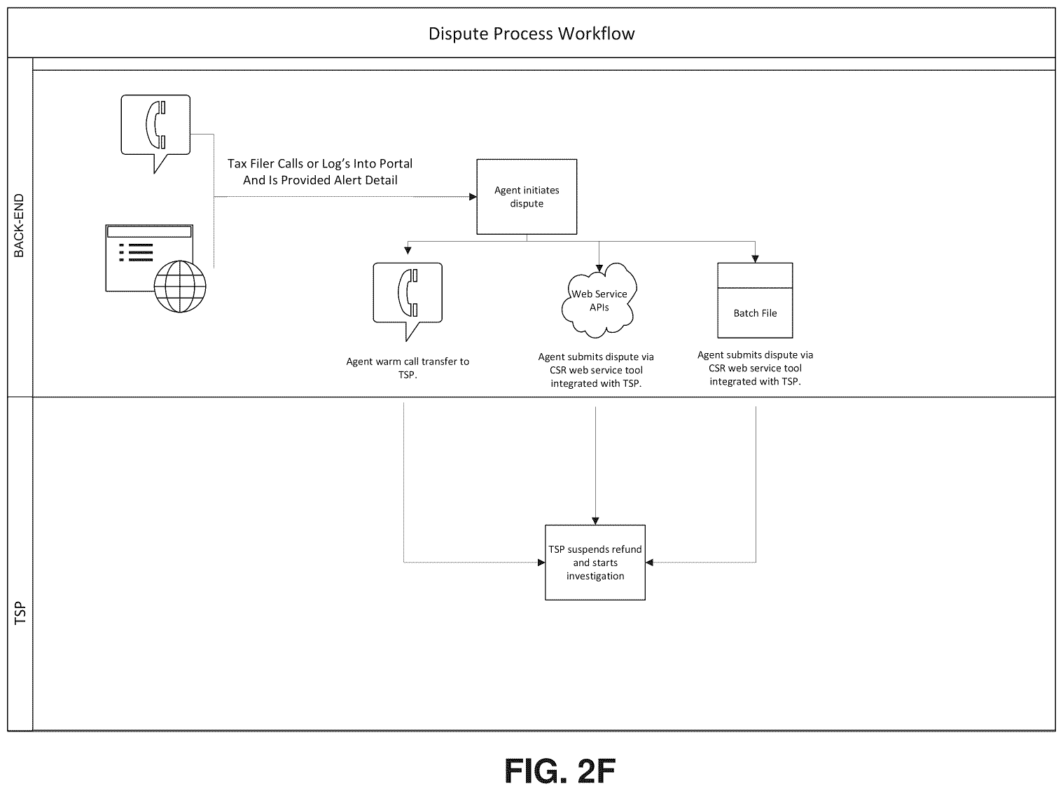

FIGS. 1C-1, 1C-2, 1D, and 1E illustrate example processes that can be implemented by embodiments of one or more components of the tax fraud alert system 120.

For example, in FIGS. IC-1 and 1C-2, a TSP system 110 (for example, a government entity server) can submit user's PII to a security platform or backend system (which may implement the tax fraud alert system 120 shown in FIG. 1B). The backend system can process the PII to identify a correct tax payer and send an alert to the tax payer. The backend system can also include a remediation center such as, for example, a call center or a web portal which can receive reports from tax filers regarding possible fraud or receive confirmations of tax filings from the tax filers who received an alert from that tax fraud alert system 120 as shown in FIG. 1C-1.

In some embodiments, the security platform or backend system (for example a tax notification system) can send the taxpayer other notices throughout the tax processing life cycle if a TSP selects this notification option. For example, as illustrated in FIG. 1C-2, the notices may be available for when tax is filed, and then later, when the tax processing is completed. The notices can also include the results from various stages of the tax processing life cycle. For example, results could be success or additional info needed, or an audit notice, or expect a refund in N days, or a tax refund was sent, and so forth.

### 1. Tax Alert Processes-First Example

FIG. 1C-1 illustrates embodiments of a tax alert process. In the illustrated embodiments, starting at (1) the tax payer (whether a user or business representative) or tax preparer files a tax form with a TSP system 110 which may include tax ID (such as, for example, social security number (SSN), individual tax payer identification number (ITIN), US government issued identifier (EIN), or other identifier), name or business name, address, phone number, and so forth. The TSP system 110 may then being processing the tax form. If there is an indication that the TSP system 110 should send a notice or alert about the tax filing to indicate that a tax filing has been submitted, then the TSP system 110 may make a call to the tax fraud alert system 120, such as, for example via an application programming interface (API) or by adding the tax payer's record to a batch file for processing. The communication may be made via a secure communication protocol, such as, for example, hypertext transfer protocol secure (HTTPS), secure file transfer protocol (SFTP), or another secure protocol. The indication may be based on the tax payer requesting a notification and/or the TSP or other system indicating that the tax payer should receive a notification.

The tax fraud alert system 120 may receive the tax filing data via the API or the batch process. If the TSP has requested notification of such errors, the tax fraud alert system 120 may send a notice to the TSP system indicating that there are and/or are not any input errors. This notice may include the information on one or more tax payer files. If there are no errors, the tax fraud alert system 120 may perform a verification process, such as, for example, the identity verification process described in FIG. 2A. The tax fraud alert system 120 may also perform a contact process, such as, for example, the best contact process described in FIG. 2B. If the tax payer is not matched, the tax fraud alert system 120 may determine whether to send a fail request receipt. If the tax payer is matches, then the tax fraud alert system 120 may generate and send a notification or alert to the tax payer using one or more of the contact channels determined by the contact process, for example using the alert notification process described in FIG. 2C. The tax payer may inquire about the notice and/or confirm whether the tax filing was correct or indicate possible fraud. The tax fraud alert system 120 may include a call center system or web portal to handle the tax payer inquiries and/or provide the tax payer access to a remote call center system or web portal which handles such inquiries.

The tax fraud alert system 120 and/or the remote call center system or portal, may generate and send an electronic notification indicating whether there is possible fraud associated with the tax payer's corresponding filing. If so, then the tax fraud alert system 120 may generate and send a notification to the TSP system 110 that the tax payer has confirmed the filing. If not, then the tax fraud alert system 120 may generate and send a notification to the TSP system 110 a possible fraud notice. In some embodiments, such notice may include instructions or an indication that is used by the TSP to stop or cancel a refund request. Such notifications may be sent to the TSP system 110 via a secure protocol, such as, for example, HTTPS, SFTP, or another secure protocol.

The TSP system 110 receives the notification and determine whether there is possible fraud using the notification. If so, the TSP system 110 may generate instruction to stop or cancel any refund processing and/or to initiate an investigation of the potential fraud. If not, then the TSP system 110 may resume with its normal tax processing. The TSP system may determine whether there is possible fraud based solely on the notification, based in part on the notification, and/or based on its own independent analysis of the tax payer filing. If the investigation determines that there is no fraud, then the TSP system 110 may resume with its normal tax processing.

### 2. Tax Alert Processes-Second Example

FIG. 1C-2 illustrates embodiments of a tax alert process. In the illustrated embodiments, starting at (1) the tax payer (whether a user or business representative) or tax preparer files a tax form with a TSP system 110 which may include tax ID (such as, for example, social security number (SSN), individual tax payer identification number (ITIN), US government issued identifier (EIN), or other identifier), name or business name, address, phone number, and so forth. The TSP system 110 may then being processing the tax form. If there is an indication that the TSP system 110 should send a notice or alert about the tax filing to indicate that a tax filing has been submitted, then the TSP system 110 may make a call to the tax fraud alert system 120, such as, for example via an application programming interface (API) or by adding the tax payer's record to a batch file for processing. The communication may be made via a secure communication protocol, such as, for example, hypertext transfer protocol secure (HTTPS), secure file transfer protocol (SFTP), or another secure protocol. The indication may be based on the tax payer requesting a notification and/or the TSP or other system indicating that the tax payer should receive a notification.

The tax fraud alert system 120 may receive the tax filing data via the API or the batch process. If the TSP has requested notification of such errors, the tax fraud alert system 120 may send a notice to the TSP system indicating that there are and/or are not any input errors. This notice may include the information on one or more tax payer files. If there are no errors, the tax fraud alert system 120 may perform a verification process, such as, for example, the identity verification process described in FIG. 2A. The tax fraud alert system 120 may also perform a contact process, such as, for example, the best contact process described in FIG. 2B. If the tax payer is not matched, the tax fraud alert system 120 may determine whether to send a fail request receipt. If the tax payer is matches, then the tax fraud alert system 120 may generate and send a notification or alert to the tax payer using one or more of the contact channels determined by the contact process, for example using the alert notification process described in FIG. 2C. The tax payer may inquire about the notice and/or confirm whether the tax filing was correct or indicate possible fraud. The tax fraud alert system 120 may include a call center system or web portal to handle the tax payer inquiries and/or provide the tax payer access to a remote call center system or web portal which handles such inquiries.

In (2), the TSP system 110 processes the tax form. If there is an indication that the TSP system 110 should send a notice or alert about the tax filing, then the TSP system 110 may make a call to the tax fraud alert system 120, such as, for example via an API or by adding the tax payer's record to a batch file for processing. The communication may be made via a secure communication protocol, such as, for example, HTTPS, SFTP, or another secure protocol. The indication may be based on the tax payer requesting a notification and/or the TSP or other system indicating that the tax payer should receive a notification.

The tax fraud alert system 120 may receive the taxes processed data via the API or the batch process. If the TSP has requested notification of such errors, the tax fraud alert system 120 may send a notice to the TSP system indicating that there are and/or are not any input errors. This notice may include the information on one or more tax payer files. If there are no errors, the tax fraud alert system 120 may generate and send a notification or alert to the tax payer that the taxes have been processed, such as, for example, using one or more of the contact channels determined by the contact process, for example using the alert notification process described in FIG. 2C. The tax payer may inquire about the notice and/or confirm whether the tax filing was correct or indicate possible fraud. The tax fraud alert system 120 may include a call center system or web portal to handle the tax payer inquiries and/or provide the tax payer access to a remote call center system or web portal which handles such inquiries.

If there is a pending refund, then in (3), the TSP processes the refund. If there is an indication that the TSP system 110 should send a notice or alert about the refund, then the TSP system 110 may make a call to the tax fraud alert system 120, such as, for example via an API or by adding the tax payer's record to a batch file for processing. The communication may be made via a secure communication protocol, such as, for example, HTTPS, SFTP, or another secure protocol. The indication may be based on the tax payer requesting a notification and/or the TSP or other system indicating that the tax payer should receive a notification.

The tax fraud alert system 120 may receive the refund data via the API or the batch process. If the TSP has requested notification of such errors, the tax fraud alert system 120 may send a notice to the TSP system indicating that there are and/or are not any input errors. This notice may include the information on one or more tax payer files. If there are no errors, the tax fraud alert system 120 may generate and send a notification or alert to the tax payer that the refund has been sent, such as, for example, using one or more of the contact channels determined by the contact process, for example using the alert notification process described in FIG. 2C. The tax payer may inquire about the notice and/or confirm whether the tax filing was correct or indicate possible fraud. The tax fraud alert system 120 may include a call center system or web portal to handle the tax payer inquiries and/or provide the tax payer access to a remote call center system or web portal which handles such inquiries.

### 3. Tax Alert Processes-Third Example

As another example, in FIG. 1D, a user can submit a tax form with PII (for example, name, address, phone number, bank account information, and/or social security number) to one or more TSP systems 110 (Block 1). The TSP system 110 can run a tax fraud alert system 120 appliance/API (provided by the tax fraud alert system 120) to depersonalize the data (Block 2) and then securely send the data to the tax fraud alert system 120 (Block 3), such as, for example, by encrypting fields of tax records to depersonalize the data and then write it to a batch file that is sent to the tax fraud alert system 120 on a periodic basis (for example, real time, hourly , daily, and so forth). As one example, “Michael Jones, 123 main st., 123-45-6789” may transform to TSP ID “A12BCD6748HU23J”. The tax fraud alert system 120 may then use the same appliance/API to add the TSP ID to the relevant backend data sets and also send the TSP batch file to the component in the system to perform the various analytics and checks (Block 4) (for example, to the back-end system components, the identity verification engine 122 and best contact engine 124). The system components conduct the analytics and checks and return a response file back to the consumer-facing components of the tax fraud alert system 120 with notification information and the results of the fraud checks such as, for example, whether checks on name, address, email, phone number, SSN, and/or bank account passed or failed (Block 5). The consumer-facing components of the tax fraud alert system 120 then notify the tax payer or customer of the tax submission and provide a portal to track flagged fraud cases and a portal to remediate the issue, such as via an online portal or a call center (Block 6). The user may be notified via one or more channels, such as, for example, email, SMS messaging, and/or direct mail. The consumer-facing components of the tax fraud alert system 120 may also notify the TSP of the potential fraud risk so that the TSP can place a hold on or cancel the tax return and/or refund (Block 7a). The user may contact the remediation center to obtain help with the remediation process prior to TSP processing the tax return and sending out a refund (Block 7b).

### 4. Tax Alert Processes-Fourth Example

As another example, in FIG. 1E, a tax filer can submit a tax form with PII to one or more TSP systems 110 (Block 1). The TSP system 110 can use an API or batch interface to communicate with a fraud alert system (such as for example, the tax fraud alert system 120 shown in FIG. 1B) to securely transport tax filer's records (Block 2) such as by encrypting the PII and sending the encrypted data to the tax fraud alert system 120 (for example the front-end system accessible via an interface). The tax fraud alert system 120 can then send the data to determine the fraud risk (Block 3), for example, by sending the PII to the back-end system of the identity verification engine 122 and best contact engine 124). An alert may then be provided (Block 4), for example to the alert notification system with notification information and results of the fraud checks, such as, for example, whether checks on name, address, email, phone number, SSN, and/or bank account passed or failed. A person associated with the PII (who may or may not be the same one as the tax filer) may be notified regarding the tax filing such as via email, SMS messaging, and/or direct mail (Block 5a). In addition, the TSP may also be notified of the potential fraud risk so that the TSP can decide whether to place a hold on or cancel the tax return (Block 5b). The tax filer can then contact an entity to assist with the remediation process (Block 6), such as, for example, before the TSP processes the tax return or sends out a tax refund.

The fraud alert system, upon receiving tax filer's records, can analyze the data in the tax filer's records and send results to an alert notification engine. The alert notification engine can notify the tax filer (or another entity if the tax filer is using the other entity's identity) of the tax submission and/or notify the TSP system 110 of the potential fraud risk. The notification to the tax filer can indicate that a tax form has been filed using the entity's tax ID.

It is recognized that FIGS. 1C-1, 1C-2, 1D, and 1E represent embodiments of example systems and processes and that other systems or processes may be used. In some embodiments, the processes are performed by the tax fraud alert system 120 and/or by one of its components, such as a processor or a controls system. However, it is recognized that other components of the tax fraud alert system 120 or other components (not shown) may perform one or more of the processes. For ease of explanation, the following describes the services as performed by the tax fraud alert system 120 or one or more of its components. The example scenarios are intended to illustrate, but not to limit, various aspects of the tax fraud alert system 120. In some embodiments, the processes can vary from the exemplary flowcharts, with some blocks omitted and others added. It is also recognized that one or more blocks in the flowcharts may be optional. The tax fraud alert system 120 may be configured to perform only a subset of the blocks in the flowcharts.

### D. Tax Fraud Alert System Components

The illustrated embodiments of FIG. 1B includes a tax fraud alert system 120 which includes an identity verification engine 122, a best contact engine, 124, and an alert notification engine 126. The exemplary tax fraud alert system 120 includes a set of backend servers 128, including an FTP/Batch server 128a configured to process File Transfer Protocol or other batch requests, an API server 128b configured to provide an API portal for other systems to access the tax fraud alert system 120 and/or to make calls to third party APIs, as well as a notification server 128c configured to send and receive electronic notifications.

### 1. Identity Verification Engine (IVE)

FIG. 2A illustrates example embodiments of an identity verification engine (IVE) 122. The IVE or service 122 may use proprietary data from one or more credit bureaus 123 and other relevant data sources to find the best or a close match to the filer identity elements provided in accordance with the preferences agreed to with the TSP. If the tax filing or tax ID is for a business, the IVE rules and supporting data sources may support identifying the business representatives that should be notified of the tax filing.

In the illustrated embodiments of FIG. 2A, the IVE 122 receive inputs including rules, TSP preferences and taxpayer's tax ID and PII from the TSP. The IVE 122 may then access data to select which data to use for the identity verification based on the received inputs. The data may include data from third party data aggregators such as public record databases, fraud data, credit bureaus, and/or directories, data from proprietary databases such as credit data, non-credit data, business data, consumer data, fraud data, subprime lending data, and/or compiled data. The data is then used to verify the identity(ies) and provide notification of whether such identity(ies) were verified.

In some embodiments, some example features of the IVE 122 can include one or more of the following:
The IVE 122 can allow the TSP systems 110 to exchange information with this service via batch files or web service APIs.
The tax filer information can be processed through various software services which include information from credit report tradelines known to one or more credit bureaus as well as data on users that do not have a traditional credit history or an extensive credit history, for example subprime credit data. Some example software services for processing filer information can include a consumer data request fulfillment system (such as for example, the one described on U.S. Pat. No. 9,697,263, the disclosure of which is hereby incorporated by reference herein in its entirety for all purposes) and identity authentication services which can include a risk-based fraud detection and prevention platform which can incorporate analytics, knowledge-based authentication and flexible decision-making strategies for more accurate authentications of identities.
The matching rules in the IVE 122 can be configurable based on the preferences agreed to with the TSP. An example of the configurable matching rules is provided in the section below.
The best identity matches can be selected by the IVE 122 and provided to the Best Contact Engine (BCE) 124.
The BCE 124 verifies or identifies the contact information for the selected one or more identities and passes the one or more identities and aggregated contact information to the Alerts Notification Engine (ANE) 126.
The IVE 122 may also support fraud checks while verify the identity information received from the TSP system. Some example fraud checks can include: SSN check, multiple submissions to the same address (velocity of the same address being used, which may include physical address or IP address), multiple submissions to the same bank account, verify against deceased records, communication checks (email, phone numbers, residential address), or checking NPPI data in the tax filing against the credit bureau data to look for discrepancies and to verify communication channels. Taxpayers that have raised flags for any of the supported fraud checks can be flagged and reported back to the TSP.

Different or additional sources may also be used for this service depending on the inputs provided by the TSP and the TSP preferences for how to handle identify verification.

### Special Handling Matching Rules for Identity Verification Engine

In some embodiments, the IVE 122 can include configurable rules. Some example scenarios and configurations are described in the table below.

| Scenario | Description | Options | |
|---|---|---|---|
| No Match | No Contact Found with PII given. | Send tax alert notice to input | |
| (Unverified | | address provided by TSP | |
| Input) | | system, if any | |
| | | Do not send notice | |
| | | If using batch communication | |
| | | with TSP system, add record to | |
| | | failure list | |
| | | If using web service | |
| | | communication with TSP | |
| | | system, return error code for this | |
| | | scenario | |
| Contact Info | Contact info in filing differs from | Send tax alert notice to both the | |
| Mismatch | contact information (such as for | filing contact and the contact | |
| (Partially | example the best contact | found by service | |
| Unverified Input) | information) found by service | Send tax alert notice only to the | |
| | | best contact found by service | |
| | | Do not send notice | |
| | | If using batch communication | |
| | | with TSP system, add record to | |
| | | failure list | |
| | | If using web service | |
| | | communication with TSP | |
| | | system, return error code for this | |
| | | scenario | |
| Name Mismatch | TSP submitted name on filing and | Send notice and address the tax | |
| (Partially | it differs from name this service | alert notice to | |
| Unverified Input) | found for the Tax ID given | a. | the last name submitted on |
| | | | filing, or |
| | | b. | last name found by the |
| | | | service, or |
| | | c. | both of the above, or |
| | | d. | none of the above |
| | | Use a generic term such as tax filer | |
| | | Do not send notice | |
| | | If using batch communication | |
| | | with TSP system, add record to | |
| | | failure list | |
| | | If using web service | |
| | | communication with TSP | |
| | | system, return error code for this | |
| | | scenario | |
| No Filing Name | TSP chooses to submit the Tax | Send notice and | |
| Given (Partially | ID and omit the name | a. | Address the tax alert to the |
| Unverified Input) | | | name found by the service, |
| | | | if any, or |
| | | b. | Do not address the alert to |
| | | | anyone, |
| | | c. | Use a generic term chosen |
| | | | by TSP, such as “tax filer” |

| | | |
|---|---|---|
| Multiple Filings | Tax ID has been seen before by | Notice can be sent for a contact |
| | the service. Same person may | (or the best contact) found for |
| | have multiple filings for personal | the tax ID submitted each time a |
| | and business(es) | record of filing is sent by the TSP. |
| Prison contact | A contact or the best contact | Send alert as with any other |
| | found is a prison or halfway | address |
| | house | Do not send alert |
| Tax ID flagged as | The tax ID given is flagged as | Send alert anyway following |
| Deceased | deceased in the relevant Death | usual rules |
| | Master Files | Do not send notice |
| | | If using batch communication |
| | | with TSP system, add record to |
| | | failure list |
| | | If using web service |
| | | communication with TSP |
| | | system, return error code for this |
| | | scenario |
| Tax ID flagged as | The tax ID is not listed as issued | Send alert anyway following |
| Not Yet Issued | by the appropriate authority | usual rules |
| | | Do not send notice |
| | | If using batch communication |
| | | with TSP system, add record to |
| | | failure list |
| | | If using web service |
| | | communication with TSP |
| | | system, return error code for this |
| | | scenario |
| Tax ID Issue Date | The tax ID was issued on a date | Send alert anyway following |
| Discrepancy | prior to the date of birth of the tax | usual rules |
| | filer, if given or the tax ID was | Do not send notice |
| | issued too recently. How recent | If using batch communication |
| | is configured by the TSP. | with TSP system, add record to |
| | | failure list |
| | | If using web service |
| | | communication with TSP |
| | | system, return error code for this |
| | | scenario |

### 2. Best Contact Engine (BCE)

FIG. 2B illustrates example embodiments of a contact engine or best contact engine (BCE) 124. The BCE or service 124 can use proprietary data from one or more credit bureaus and other relevant data sources to find contact information 125 (for example, a matched contact information or the best contact information) for the tax alerts and notify the tax filers in accordance with the preferences agreed to with the TSP.

In the illustrated embodiments of FIG. 2B, the BCE 124 receives input such as rules, TSP preferences, and identity(ies) from the IVE 122. The BCE 124 may then review data to provide contact details. The data may include data from third party data aggregators such as phone or mobile data aggregators, directories, and/or skip trace databases, as well as data from proprietary database such as consumer data, business data, change of address data, and/or marketing data. The BDE 124 then generates an electronic indication of contact details.

The types of information and software services that can be executed together with the BCE 124 for locating the contact information can include one or more of the following:
Credit tradelines data, such as credit header data or tax filers' contact information.
Sub-prime loan data which adds coverage for parts of the population that use less traditional lending outlets.
Marketing tracking data, such as data which link fragmented and incomplete data including email, social and personally identifiable information (PII), across channels and devices. Examples of such marketing tracking data are also described in U.S. Pat. No. 9,767,309, the disclosure of which is hereby incorporated by reference herein in its entirety for all purposes.
Identity authentication services which can include a risk-based fraud detection and prevention platform which can incorporates analytics, knowledge-based authentication and flexible decision-making strategies for more accurate authentications of identities.
National change of address services, such as for example monitoring services for change of address.
Phone directory services including Mobile Network Operators (MNOs).

Different or additional sources may also be used for this service depending on the inputs provided by the TSP and the TSP preferences for how to handle matching ambiguities.

### 3. Alert Notification Engine (ANE)

FIG. 2C illustrates example embodiments of an alert notification engine (ANE) 126. After locating the contact information for each verified tax filer, in some embodiments, the ANE or service 126 can follow the rules agreed to with the TSP 127 regarding who to contact and how to handle identity matching ambiguities or discrepancies. The notification processes for this service can manage distribution channel and distribution schedule.

In the illustrated embodiments of FIG. 2C, the ANE 126 receives the contact data from the BCE 124 and then generates alert packages to be sent to recipients based on the TSP configured distribution channels. The alert data may be sent to a web service API or to a batch file to allow the tax filer or product/service subscriber to access the alert information. The tax filer may have to provide certain information to access the alert, such as a logon, a filing data, a filer ID, a refund amount, and so forth. The alert data may also, or instead, be provided to a configured template which will be loaded and sent to a desired channel such as email, direct mail, SMS messaging, and/or a phone call.

In some embodiments, distribution channels provide TSP several options for sending the alert to the tax filer. Some example distribution channels include:
The TSP can choose to use the alert notification engine to deliver the alerts. If this channel is chosen, the TSP can configure the notifications (templates), with the styling and copy they choose. The TSP can also select how the notifications are sent. Notification types include: direct mail, email, SMS text, social media messages, and/or phone voice messages. The TSP may choose one or more of these communication channels or decide to waterfall notifications to these channels: for example, starting with SMS text, and only using email and/or direct mail if the SMS text to the identified phone number fails or a mobile phone is not located for the identity.
The TSPs can choose to send the alerts from their system. If this channel is chosen, the tax fraud alert system 120 can pass the identity, contacts, and alert information to the TSP via a web service API or a batch file process. The TSP would then be responsible for sending the notice via notification channels (phone, mail, email, and so forth).
The TSP can also choose to allow the alerts to be sent to subscribers of market facing identity monitoring products. If chosen, the tax fraud alert system 120 can pass the alert information to the a 3rd party entity via web service APIs to provide as a tax filing alert within the subscriber's product.

In some embodiments, distribution schedule may be appropriate to handle large volumes. For example, the alert notification engine can avoid sending a volume of notifications at once that would result in an inquiry volume that could not be supported by the call centers.

In some embodiments, the notification may follow one or more templates which may be approved by TSPs. Selection of appropriate templates depending on TSP preferences, notification channel (for example, the template for text messages would be different than the template for emails), and PII available for a tax filer. Parameter substitution for notification templates including ways for tax payers or tax filers to authenticate that the tax alert notice is legitimate. Some examples of how to show legitimacy of the alert include one or more of:
Official Tax Service Provider letterhead for direct mail.
Official TSP logos in email.
Official TSP phone greetings or voice talent.
Partial Tax ID, if approved by TSP. This could be made available only by call center agents or web service portal if TSP deems too sensitive to send in tax alert.
Tax Filing Date.
Name on filing if it matches name service found. Including name on filing is problematic if there is a conflict between filing and what service found.
Partial email address given at time of filing. This might be problematic in cases of fraud.
Tax filing details such as dollar amounts if Tax Service Provider is willing to submit those with each record.
Notices can include safeguards to make it difficult for fraudsters to replicate the alerts to launch phishing attacks. For example, if the TSP chooses, any emails sent could exclude direct links.
Marketing campaigns can educate the tax payers or tax filers on ways to confirm the tax alert is legitimate, for example promoting that official emails from the TSP may not include direct links.

In some embodiments, each tax alert sent can include a unique identifier that can be used by the user when contacting the branded call center, reaching the branded web portal to handle tax alert inquiries, and/or when calling the TSP directly to inquire about the alert or to dispute the tax filing.

### 4. Alert Notification Support and Remediation via Portal and Call Center

As part of this solution, in some embodiments, the tax fraud alert system 120 can offer TSPs multiple options to support the tax filers that receive the tax alert notification. The alert itself can include the appropriate calls to action for the filer in accordance with the option(s) the TSP selected for offering alert notification support. Some examples of alert notification support can include one or more of:
Refer filers to a call center hosted by the TSP. This option is supported by providing the TSP with information about the tax alert notifications sent including the ways the filer was contacted, when, and, if necessary, the actual contact details used for the notification(s).
Refer filers to a web portal hosted by the TSP. This option is supported by providing the TSP information about the tax alert notifications sent including the ways the filer was contacted, when, and, if necessary, the actual contact details used for the notification(s).
A hosted call center. The call center can be hosted by an entity running the tax fraud alert system 120. The call center can include training to assist filers that receive a tax alert notification or have general questions about it. The scope of what call center staff can handle or escalate to the TSP depends on TSP configuration options.
A hosted web portal. The web portal can be hosted by an entity running the tax fraud alert system 120 and be tailored to assist filers that receive a tax alert notification or have general questions about it. The functionality available in the portal depends on TSP configuration options.
In certain embodiments, the TSP may choose to host the web portal or the call center, alone or in combination.

In some embodiments, the TSP can also choose which functions may be offered by the call center or the web portal as applicable if TSP chooses to have another entity to host the call center or the web portal. Some example functions can include one or more of:
General information and questions and answers about the tax fraud alert system 120. Content and any call center scripts can be configurable and approved by the TSP.
Authentication of tax filer. TSP can be given options for authenticating the caller including 2 factor authentication, knowledge based authentication, or other proprietary authentication options.
Reviewing previously sent tax alerts.
Initiating a dispute of a tax filing.
Stop payment of a refund

For some options, such as, for example, the last two options (initiating a dispute of a tax filing and stopping payment of a refund), TSP may choose to have the host (of the call center and/or web portal) to either escalate handling of disputes and/or stop payments on refunds, or the TSP may offer a web service that allows the host to initiate a dispute programmatically via either the web portal and/or an administrative tool available to the call center staff.

### 5. Call Center Support

FIGS. 2D-1 and 2D2 illustrate flow diagrams for embodiments of call center support processes. If the TSP chooses the call center support option, the host of the call center support service can provide call center agents trained to handle inquiries from users that received a tax alert. The agents can be given training and scripts approved by the TSP with detailed instructions on how to address all possible inquiries from the end user and how to escalate issues. The scope of what the call center can handle may depend on the configurable options chosen by the TSP.

In the illustrated embodiments of FIG. 2D-1, a tax filer calls a support line and an agent searches a database with information provided to the tax filer in the alert notification to locate the tax filer. When the alert was sent, the alert may have been electronically attached to the tax filer's profile in a backend database. It is recognized that a variety of PII may be used to identify a tax filer, including, for example, alert ID (for example, a unique identifier generated for an alert), a filer ID (for example, the social security number of entity number of the filer provided by the TSP), and/or a return ID (for example, a unique identifier generated for the tax return submission provided by the TSP). The tax filer may be authenticated, for example, using data from the tax filer's tax return submission. The agent may initiate authentication by accessing an authentication process of a proprietary authentication service. For example, authentication questions may be asked which can be retrieved based on the located user's social security number, address, and so forth. If the tax filer passes the authentication, the agent may be directed by the system to answer the tax filer's questions and/or initiate a dispute process. If the tax filer does not pass the authentication, the agent may be presented with instructions to inform the tax payer or customer of the inability to verify the tax filer's information.

In the illustrated embodiments of FIG. 2D-2, the system determines whether the TSP is using a contracted call center or the TSP's call center. If a contracted call center, then a call is received by the contracted call center, the agent searches a backend database by tax return ID to find the tax return submission, the backend authenticates the user using data from the tax return submission and backend database (for example, simple authentication using submission data, or non-credit knowledge based authentication), if the user passes the authentication the agent files a ticket in the call center system and includes call disposition data (for example general questions and answer, fraud event information), the reporting collects the call center tickets on a regular basis (for example, in real time, hourly, daily, and so forth)and send them to the TSP for investigation (for example, via FTP, SFPT, restful reporting service, and so forth). If a TSP call center, the TSP receives the call. The TSP agent searches the TSP database by tax return ID to find the tax return submission, the TSP authenticates the user using data from the tax return submission, if the user passes the authentication, the submission is held by TSP pending TSP's fraud investigation.

In both scenarios, next the TSP may investigate the submission and cancel the fraudulent return or puts the return on hold. The TSP contacts the user and provides them a code to file their real tax return when ready. In some embodiments, this could be a notification from the backend (for example, the tax fraud alert system 120) which may pass the status of the investigation to the backend with a tax submission code. It is recognized that some TSPs may have a process for generating unique IDs for victims of identity theft. This ID may be entered to file a tax return and may be already integrated into the TSP. This could be used when the user is ready to submit their real return.

It is recognized that one or more of the TSPs may use a different process and so the embodiments of FIG. 2D-2 are meant to illustrate example embodiments and not limit the disclosure.

In some embodiments, the host's databases (or other databases) may be used to implement one or more of the following functions related to call center support:
When alert is sent, it can be attached to a tax payer or customer profile in the host database. Forms of PII that can be used to identify the tax payer or customer can be:
   Alert ID: Unique # Generated for the alert;
   Filer ID: SSN or EIN of the filer provided by the TSP; and/or
   Tax Form ID: Unique ID generated for the tax form submission provided by the TSP.
Authenticate the identity of the user using the PII and any tax filing details provided by the TSP system, plus proprietary methods of authentication.
Review the tax alerts sent.
Clearly guide the user through next steps if the tax filing is not recognized by the user
Ability to view and relay status of previous inquiries started by the end user. This may require that the TSP system 110 provide a way to look up status or a way for the TSP system 110 to push inquiry or dispute status to the service.

### 6. Web Portal Support

FIG. 2E illustrates a flow diagram for embodiments of a web portal support process. If the TSP chooses the web portal support option, a host of the web portal can provide a web service portal to service users with the look, feel, and content approved by the TSP. The portal can be designed to handle inquiries from users that received a tax alert.

In the illustrated embodiments of FIG. 2E, the backend system receives an indication that a tax filer has logged onto the web portal and retrieves alert information associated with the user. The identity verification process is initiated. For example, in some embodiments, prior to any information being shared, the system may prompt knowledge based authentication questions and/or use proprietary authentication services. The knowledge based authentication questions may be based off of the located user's social security number, entity number, address and so forth. If the user's passes authentication, the alert information and dispute information may be display on a user interface. If the user does not pass authentication, the portal may inform the user of its inability to verify the user.

The portal can have automated ways or static content that address one or more of the following functions:
Authenticate the identity of the user using the PII and any tax filing details provided by the TSP, plus proprietary methods of authentication.
Present the tax alert(s) details.
Clearly guide the user through next steps if the tax filing is not recognized by the user
Inform the TSP via an automated or offline process that the user disputes having filed taxes. This process could either suspend delivery of the refund or initiate additional investigation by the TSP.
Ability to display status of previous inquiries started by the end user. This requires that the TSP provide a way to look up status or a way for the TSP to push inquiry or dispute status to the service.

It is recognized that white labeling services may be provided allowing one or more tax filer facing systems to be branded with one entity and one or more backend processes or services to be run by an entity other than the entity associated with the branding. In such case, the white labeling services may be hosted by the backend processes and/or a system of the entity associated with the branding.

### 7. Dispute Process

FIG. 2F illustrates a flow diagram for embodiments of a dispute process. In the illustrated embodiments of FIG. 2F, a tax filer calls or logs onto a portal and is provided alert details. An agent may initiate a dispute and may then transfer the call to the appropriate TSP, submit the dispute via a web service tool which may be integrated with the appropriate TSP, and/or submit the dispute via a batch service tool which may be integrated with the appropriate TSP. The TSP then receives the dispute and may suspend the refund and initiate an investigation. The web service tool and/or batch service tool may be provided by a customer service representative (CSR) system.

The TSP can establish manual or automated processes that allow the tax fraud alert system 120 to perform one or more of the following:
Notify the TSP that a user disputes a tax filing and either suspend a refund or initiate additional investigation of the tax filing,
   For example, this can be achieved by:
      Warm call transfer to the TSP, or
      Automated process via web services or batch file.
Provide status of an inquiry or dispute previously submitted, including resolution.
   For example, this can be achieved by:
      Batch file, or
      Web services.

### E. Pre-Launch Service Configuration

In some embodiments, the tax fraud alert system 120 also includes one or more components and processes to provide automated configuration services for the other systems, such as the TSP systems, third party vendors, or third party data suppliers. The configuration may be provided via a remotely accessible portal that allows a user of a third party system to access the portal, review the options for configuration, provide electronic indications of the selected options, and instruct the portal to store the options. Prior to launching the tax fraud alert system 120, the TSP can configure one or more of the following options:
PII to use: What minimum and optional PII to submit to the service.
Handling matching scenarios
   How to handle ambiguities or discrepancies of identity based on the PII provided. The TSP can have the service configured to only send notices to tax filers that have been verified, for example, the contact information found by the service matches the contact information in the tax filing; and/or to also send tax alerts to the contact information in the tax filing, even if that information is unverified by the service. For example, if TSP only provides a tax ID and the service locates several names tied to that tax ID, the service can be configured to perform one or more of the following actions:
      Notify one or more or all of the names found or to not send notices; and/or
      Callback (automatically in batch, web service, or via a call center) to the TSP system 110 to suspend delivery of a refund or initiate further investigation before sending the refund.
   Or for example, if a TSP system 110 provides the tax ID, name, and address used in the tax form filed and the tax fraud alert system 120 finds a different name and/or address tied to the tax ID, the service can be configured to perform one or more of the following actions:
      Send notices using the PII used in the tax filing and/or to the PII found by the service; and/or
      Callback to the TSP system 110 to suspend delivery of a refund or initiate further investigation before sending the refund.
   Whether to flag cases of tax ID typos—whether to have the service indicate when a tax ID does not match the PII provided, but a transposed digit in the tax ID would resolve the discrepancy. This may be difficult to automate but it is possible to do using credit bureau data or other third party data.
   Whether to receive error responses for inputs submitted, including bad input data, ambiguous or contradictory results, no matching results.

A table enumerating known conditions and options for how to handle each can be presented to the TSP system.
Media used for notices: Whether to notify tax filers via direct mail, and/or email, phone, or text message.
Who to notify
   Whether to notify both parties in a joint filing.
   Whether to make exceptions on whom to send notices to, for instance, do not send notices to prisons or those where the tax ID is listed as deceased or unverified tax filers.
When to notify: Whether to notify for one or more of the following events:
   Main tax form is filed (for example, 1040 or 1040-EZ) or other selected forms.
   Tax form filed has completed processing or requires more details.
   Suspended refund or suspended processing (for example, due to suspected fraud).
   Resolution of a suspended refund or suspended processing.
Who to address notices to: Whether to address notices to the name used in the tax filing and/or to the name(s) found by the service.
Handling user inquiries
   Whether to have this solution host a call center and/or a web portal to answer inquiries from users that receive a tax alert.
   If this service is to host a web portal on behalf of the TSP, whether that portal can offer identity theft services to the user.
   Whether to receive real-time callbacks when users respond to the call center and/or the web portal provided by the service.
   Whether to provide an automated web service callback mechanism or other scalable process to suspend delivery of a tax refund or initiate further investigation.
Method of data transfer: Whether to exchange information with this service via batch files, web service calls, call centers, and/or offline.

### F. Inputs supported by the Tax Alerts Service

In some embodiments, the TSP may be offered configurable options for what information to share and how to share it. Some features in this solution can only be available if certain optional inputs are provided. For example, the ability to present to the end user dollar amounts specific to their tax filing as a way for the user to gain confidence that the notification is legitimate would only be possible if the TSP is willing to provide such dollar amounts for use in this solution. Omission of optional PII might reduce the efficacy of the service or render some features unavailable.

In some embodiments, the PII submitted can be expected to be what the tax filer provided in the tax form filing and does not necessarily have to be verified by the TSP before submitting the PII to the service. Examples of submitted PII may include one or more of the following:
ID*: Tax ID, ITIN, EIN or any tax identifier supported by the local, state, or federal government agency collecting the taxes. It can be used to confirm a match and find the contact information for sending notices. The tax ID may be for an individual or a business entity.
Full Name*: First Name, Middle Name, Last Name, Suffix. If given, it can be used to help confirm a match and potentially to address the notices sent depending on TSP preferences.
Address*: street1, street2, city, state, postal code or other applicable fields if the address is outside the USA.
Date of Birth: If given, it can be used to help confirm a match.
Phone: If given, it can be used to help confirm a match and possibly for notification.
Email: If given, it can be used to help confirm a match and possibly for notification.
Filing status: Any status supported by the local, state, or federal government agency collecting the taxes. For example, married filing jointly. If given, it can be used in the tax alert to give the user more confidence that the notice is legitimate.
Joint Filer Tax ID: Tax ID, ITIN, EIN or any tax identifier supported by the local, state, or federal government agency collecting the taxes. It can be used to confirm a match and find the contact information (such as for example, the best contact information) for sending notices. Joint filer information should only be provided if the TSP wants to notify both parties in a joint filing.
Joint Filer Full Name: First Name, Middle Name, Last Name, Suffix. If given, it can be used to help confirm a match and potentially to address the notices sent depending on TSP preferences. Joint filer information should only be provided if the TSP wants to notify both parties in a joint filing.
Joint Filer Date of Birth: If given, it can be used to help confirm a match. Joint filer information should only be provided if the TSP wants to notify both parties in a joint filing.
Joint Filer Phone: If given, it can be used to help confirm a match and possibly for notification
Joint Filer Email: If given, it can be used to help confirm a match and possibly for notification. Joint filer information may only be provided if the TSP wants to notify both parties in a joint filing.
Tax Filing Date: If given, it can be used in the tax alert to give the user more confidence that the notice is legitimate.
Tax Preparer: Name of tax preparer software, company, or person. If given, it can be used in the tax alert to give the user more confidence that the notice is legitimate.
Tax Filing Detail1 Label: If given, it can be used in the tax alert to give the user more confidence that the notice is legitimate. For example, “Adjusted Gross Income” submitted in tax filing. It could also be used to authenticate the user if s/he calls or visits the web portal to inquire about the notice.
Tax Filing Detail1: If given, it can be used in the tax alert to give the user more confidence that the notice is legitimate. For example, Adjusted Gross Income amount submitted in tax filing. It could also be used to authenticate the user if s/he calls or visits the web portal to inquire about the notice.
Tax Filing Detail2 Label: If given, it can be used in the tax alert to give the user more confidence that the notice is legitimate. For example, “Previous Year Refund or Payment”. It could also be used to authenticate the user if the user calls or visits the web portal to inquire about the notice.
Tax Filing Detail2: I given, it can be used in the tax alert to give the user more confidence that the notice is legitimate. For example, Previous Year Refund or Payment amount. It could also be used to authenticate the user if he or she calls or visits the web portal to inquire about the notice.

Where “*” represents either tax ID or Full Name and Address may be required for this service in some embodiments. In some embodiments, there is no requirement for TSP to perform input validation such as ensuring Tax ID is not in death master file or has been issued long enough ago to justify a tax filing.

### G. Example Computing System Implementation and Architecture

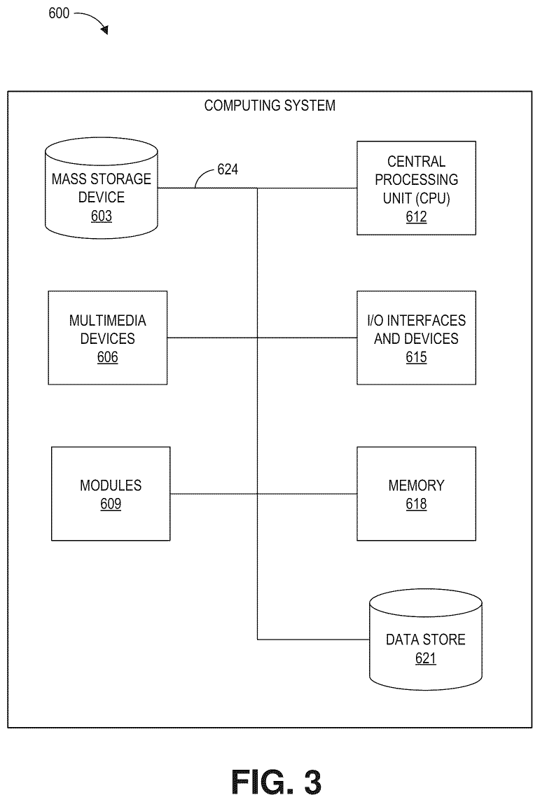

FIG. 3 illustrates a general architecture of a computing system for processing implementing various aspects of the present disclosure. Many or all of the components of the computing system shown in FIG. 3 may be included in the various computing devices and systems discussed herein, including the TSP systems, the tax fraud alert system 120, the tax filer system 130, the third party vendor systems, the third party data systems, and so forth. The computing system may include, for example, a personal computer (such as, for example, IBM, Macintosh, Microsoft Windows compatible, OS X compatible, Linux/Unix compatible, or other types of computing systems, alone or in combination), a server, a workstation, a laptop computer, a smart phone, a smart watch, a personal digital assistant, a kiosk, a car console, a tablet, or a media player. In one embodiment, the computing system's processing system 600 includes one or more central processing units (CPU) 612, which may each include a conventional or proprietary microprocessor specially configured to perform, in whole or in part, one or more of the features described above. The processing system 600 further includes one or more memory 618, such as random access memory (RAM) for temporary storage of information, one or more read only memory (ROM) for permanent storage of information, and one or more mass storage device 603, such as a hard drive, diskette, solid state drive, or optical media storage device. A data store 621 may also be included. In some implementations, the data store 621 may be designed to handle large quantities of data and provide fast retrieval of the records. To facilitate efficient storage and retrieval, the data store 621 may be indexed using one or more of compressed data, identifiers, or other data, such as that described above.

Typically, the components of the processing system 600 are connected using a standards-based bus system 624. In different embodiments, the standards-based bus system 624 could be implemented in Peripheral Component Interconnect (PCI), Microchannel, Small Computer System Interface (SCSI), Industrial Standard Architecture (ISA) and Extended ISA (EISA) architectures, for example. In addition, the functionality provided for in the components and modules of processing system 600 may be combined into fewer components and modules or further separated into additional components and modules.

The processing system 600 is generally controlled and coordinated by operating system software, such as Windows XP, Windows Vista, Windows 7, Windows 8, Windows 10, Windows Server, Unix, Linux, SunOS, Solaris, iOS, MAC OS X, Blackberry OS, Android, or other operating systems. In other embodiments, the processing system 600 may be controlled by a proprietary operating system. The operating system is configured to control and schedule computer processes for execution, perform memory management, provide file system, networking, I/O services, and provide a user interface, such as a graphical user interface (GUI), among other things. The GUI may include an application interface and/or a web-based interface including data fields for receiving input signals or providing electronic information and/or for providing information to the user in response to any received input signals. A GUI may be implemented in whole or in part using technologies such as HTML, Flash, Java, .net, web services, and RSS. In some implementations, a GUI may be included in a stand-alone client (for example, thick client, fat client) configured to communicate (for example, send or receive data) in accordance with one or more of the aspects described.

The processing system 600 may include one or more commonly available input/output (I/O) devices and interfaces 615, such as a keyboard, stylus, touch screen, mouse, touchpad, and printer. In one embodiment, the I/O devices and interfaces 615 include one or more display devices, such as a monitor, that allows the visual presentation of data to a user. More particularly, a display device provides for the presentation of GUIs, application software data, and multimedia presentations, for example. The processing system 600 may also include one or more multimedia devices 606, such as speakers, video cards, graphics accelerators, and microphones, for example.

In the embodiment of FIG. 3, the I/O devices and interfaces 615 provide a communication interface to various external devices. The processing system 600 may be electronically coupled to one or more networks, which comprise one or more of a LAN, WAN, cellular network, satellite network, and/or the Internet, for example, via a wired, wireless, or combination of wired and wireless communication link. The networks communicate with various computing devices and/or other electronic devices via wired or wireless communication links. The communication can occur using various protocols such as, for example, the File Transfer Protocol (FTP), Secure File Transfer Protocol (SFTP), Hypertext Transfer Protocol (HTTP), Transmission Control Protocol/Internet Protocol (TCP/IP), and so on.

In some embodiments, information may be provided to the processing system 600 over a network from one or more data sources. The data sources may include one or more internal and/or external data sources. In some embodiments, one or more of the databases or data sources may be implemented using a relational database, such as Sybase, Oracle, CodeBase and Microsoft® SQL Server as well as other types of databases such as, for example, a flat file database, a non-relational database, an entity-relationship database, and object-oriented database, and/or a record-based database.

In general, the word “module,” as used herein, refers to logic embodied in hardware or firmware, or to a collection of software instructions, possibly having entry and exit points, written in a programming language, such as, for example, Java, Lua, C, or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the processing system 600, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules. They may be represented in hardware or firmware. Generally, the modules described herein refer to logical modules that may be combined with other modules or divided into sub-modules despite their physical organization or storage.

In the example of FIG. 3, the modules 609 may be configured for execution by the CPU 612 to perform, in whole or in part, any or all of the process discussed above. The processes may also be performed by one or more virtual machines. For example, the processes may be hosted by a cloud computing system. In some embodiments, one or more components of the processing system 600 may be part of the cloud computing system. Additionally or alternatively, the virtualization may be achieved at the operating system level. For example, the one or more processes described herein may be executed using application containerization. The one or more processes may also be implemented on a Lambda architecture designed to handle mass quantities of data by taking advantage of the batch processing and the stream processing.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated, via software code modules executed by a computing system that includes one or more computers or processors. In some embodiments, at least some of the processes may be implemented using virtualization techniques such as, for example, cloud computing, application containerization, or Lambda architecture, so on, alone or in combination. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a virtual machine, a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

1. (canceled)

2. A system comprising:
one or more data stores configured to store computer-executable instructions;
a network interface configured to communicate with a plurality of network service devices; and
one or more physical computer processors in communication with the one or more data stores, wherein the computer-executable instructions, when executed, configure the one or more physical computer processors to:
receive and store, from a tax authority via an application program interface or a batch process over the network interface, an electronic batch file that includes a plurality of electronic requests, wherein each electronic request of the plurality of electronic requests is for a filing of an application, wherein a first electronic request of the plurality of electronic requests is:
(i) submitted by a second user; and
(ii) associated with a first application that includes first user data comprising a depersonalized alphanumeric identifier that is generated based at least in part on encrypted personally identifying information (PII) associated with a first user, the first user being different from the second user;
based at least in part on the first electronic request and a configurable rules engine, determine a match corresponding to an identity of the first user by comparing at least a portion of the first user data to first verification data, wherein at least a first portion of the first verification data is different from the first user data received from the tax authority;
prior to an indication of fraud, based at least in part on the determination of the match, transmit, to a first user device associated with the first user via the network interface, a notification associated with the match regarding the first application, wherein the notification is transmitted to a type of contact included in the first portion of the first verification data;
receive, in response to the notification and from the first user device via the network interface, an electronic communication indicating that the first application or the first electronic request is possibly fraudulent;
determine, based at least in part on the electronic communication, that the first application or the first electronic request is fraudulent; and
generate and transmit, to the tax authority via the network interface, electronic instructions configured to stop processing the first application as requested by the first electronic request.

3. The system of claim 2, wherein the first user data further includes personally identifying information (PII) associated with the first user.

4. The system of claim 2, wherein the one or more physical computer processors are further configured to:
transmit, to an external third party entity via the network interface, the electronic instructions configured to stop the processing of the first application.

5. The system of claim 2, wherein the depersonalized alphanumeric identifier comprises all letters, all numbers, or a mix of letters and numbers.

6. The system of claim 2, wherein the one or more physical computer processors are further configured to:
associate the depersonalized alphanumeric identifier to the first verification data.

7. The system of claim 2, wherein the first verification data associated with the first user is based at least in part on proprietary and public datasets.

8. A computerized method comprising:
receiving and storing, from a tax authority via an application program interface or a batch process over a network interface, an electronic batch file that includes a plurality of electronic requests, wherein each electronic request of the plurality of electronic requests is for a filing of an application, wherein a first electronic request of the plurality of electronic requests is:
(i) submitted by a second user; and
(ii) associated with a first application that includes first user data comprising a depersonalized alphanumeric identifier that is generated based at least in part on encrypted personally identifying information (PII) associated with a first user, the first user being different from the second user;
based at least in part on the first electronic request and a configurable rules engine, determining a match corresponding to an identity of the first user by comparing at least a portion of the first user data to first verification data, wherein at least a first portion of the first verification data is different from the first user data received from the tax authority;
prior to an indication of fraud, based at least in part on the determination of the match, transmitting, to a first user device associated with the first user via the network interface, a notification associated with the match regarding the first application, wherein the notification is transmitted to a type of contact included in the first portion of the first verification data;
receiving, in response to the notification and from the first user device via the network interface, an electronic communication indicating that the first application or the first electronic request is possibly fraudulent;
determining, based at least in part on the electronic communication, that the first application or the first electronic request is fraudulent; and
generating and transmitting, to the tax authority via the network interface, electronic instructions configured to stop processing the first application as requested by the first electronic request.

9. The computerized method of claim 8, wherein the first user data further includes personally identifying information (PII) associated with the first user.

10. The computerized method of claim 8, further comprising:
generating and transmitting, to an external third party entity via the network interface, the electronic instructions configured to stop the processing of the first application.

11. The computerized method of claim 8, wherein the depersonalized alphanumeric identifier comprises all letters, all numbers, or a mix of letters and numbers.

12. The computerized method of claim 8, further comprising:
associating the depersonalized alphanumeric identifier to the first verification data.

13. The computerized method of claim 8, wherein the first verification data associated with the first user is based at least in part on proprietary and public datasets.

14. A non-transitory storage medium for storing instructions adapted to be executed by a processor to perform a method for automatically detecting fraudulent tax filings, the instructions comprising:
receiving and storing, from a tax authority via an application program interface or a batch process over a network interface, an electronic batch file that includes a plurality of electronic requests, wherein each electronic request of the plurality of electronic requests is for a filing of an application, wherein a first electronic request of the plurality of electronic requests is:
(i) submitted by a second user; and
(ii) associated with a first application that includes first user data comprising a depersonalized alphanumeric identifier that is generated based at least in part on encrypted personally identifying information (PII) associated with a first user, the first user being different from the second user;
based at least in part on the first electronic request and a configurable rules engine, determining a match corresponding to an identity of the first user by comparing at least a portion of the first user data to first verification data, wherein at least a first portion of the first verification data is different from the first user data received from the tax authority;
prior to an indication of fraud, based at least in part on the determination of the match, transmitting, to a first user device associated with the first user via the network interface, a notification associated with the match regarding the first application, wherein the notification is transmitted to a type of contact included in the first portion of the first verification data;
receiving, in response to the notification and from the first user device via the network interface, an electronic communication indicating that the first application or the first electronic request is possibly fraudulent;
determining, based at least in part on the electronic communication, that the first application or the first electronic request is fraudulent; and
generating and transmitting, to the tax authority via the network interface, electronic instructions configured to stop processing the first application as requested by the first electronic request.

15. The non-transitory storage medium of claim 14, wherein the first user data further includes personally identifying information (PII) associated with the first user.

16. The non-transitory storage medium of claim 14, wherein the depersonalized alphanumeric identifier comprises all letters, all numbers, or a mix of letters and numbers.

17. The non-transitory storage medium of claim 14, the instructions further comprising:
associating the depersonalized alphanumeric identifier to the first verification data.

18. The non-transitory storage medium of claim 14, wherein the first verification data associated with the first user is based at least in part on proprietary and public datasets.

19. The non-transitory storage medium of claim 14, the instructions further comprising:
transmitting, to an external third party entity via the network interface, the electronic instructions configured to stop the processing of the first application.
